(19) United States
(12) Patent Application Publication
(10) Pub. No.: US 2024/0296601 A1
(43) Pub. Date: Sep. 5, 2024

(54) SYSTEMS AND METHODS FOR DATA PROCESSING

(71) Applicant: SHANGHAI UNITED IMAGING HEALTHCARE CO., LTD., Shanghai (CN)

(72) Inventors: Wenjing CAO, Shanghai (CN); Zhengqiang ZHANG, Shanghai (CN)

(73) Assignee: SHANGHAI UNITED IMAGING HEALTHCARE CO., LTD., Shanghai (CN)

(21) Appl. No.: 18/663,002

(22) Filed: May 13, 2024

Related U.S. Application Data
(63) Continuation of application No. PCT/CN2021/131825, filed on Nov. 19, 2021.

(51) Int. Cl. G06T 11/00

(52) U.S. Cl. CPC G06T 11/008

(57) ABSTRACT

The present disclosure relates to systems and methods for data processing. The methods may include obtaining first data of a subject acquired by an imaging device, the first data relating to a truncation artifact, transforming the first data from a first form to a second form, and generating, based on the first data in the second form, truncation artifact corrected data using a data processing model.

### CROSS-REFERENCE TO RELATED APPLICATIONS

This application is a Continuation of International Application No. PCT/CN2021/131825, filed on Nov. 19, 2021, the contents of which are incorporated herein by reference.

### TECHNICAL FIELD

The present disclosure generally relates to data processing, and more particularly, relates to systems and methods for generating truncation artifact corrected data.

### BACKGROUND

A medical imaging device may generate image data related to a subject by scanning the subject. Taking a computed tomography (CT) imaging device as an example, to generate the image data, the CT imaging device may scan the subject placed in a scan field of view (FOV) of the CT imaging device using x-rays. However, under some scanning conditions, portions of the subject may be obstructed (e.g., from the x-rays) or extend beyond the scan FOV, which may result in a truncation artifact in the image data. Thus, it is desirable to develop systems and methods for correcting truncation artifact in image data, thereby improving image quality.

### SUMMARY

An aspect of the present disclosure relates to a method for data processing. The method may be implemented on a computing device having at least one storage device storing a set of instructions, and at least one processor in communication with the at least one storage device. The method may include obtaining first data of a subject acquired by an imaging device. The first data may relate to a truncation artifact. The method may further include transforming the first data from a first form to a second form, and generating, based on the first data in the second form, truncation artifact corrected data using a data processing model.

In some embodiments, the generating, based on the first data in the second form, truncation artifact corrected data using a data processing model may include generating, based on the first data in the second form, truncation artifact corrected data in the second form using the data processing model, and transforming the truncation artifact corrected data from the second form to the first form.

In some embodiments, the first data may be in a form of raw data acquired by the imaging device.

In some embodiments, the truncation artifact corrected data may be in a form of a truncation artifact corrected image or imaging data corresponding to the truncation artifact corrected image.

In some embodiments, the first data may include a first image including a truncation artifact, and the truncation artifact corrected data may include a truncation artifact corrected image.

In some embodiments, the generating, based on the first data in the second form, truncation artifact corrected data using a data processing model further may include obtaining, based on the first data in the second form, second data of a region corresponding to the truncation artifact, and generating, based on the first data and the second data, the truncation artifact corrected data using the data processing model.

In some embodiments, the first form may include a Cartesian coordinate form.

In some embodiments, the second form may include a polar coordinate form.

In some embodiments, the generating, based on the first data and the second data, the truncation artifact corrected data using the data processing model may include generating, based on the second data, intermediate data in the second form. The intermediate data may be configured to correct the truncation artifact. The generating, based on the first data and the second data, the truncation artifact corrected data using the data processing model may further include generating the truncation artifact corrected data by combining the first data and the intermediate data.

In some embodiments, the generating the truncation artifact corrected data by combining the first data and the intermediate data may include determining weighted intermediate data based on a weight, transforming the weighted intermediate data from the second form to the first form, and determining the truncation artifact corrected data by combining the first data and the weighted intermediate data in the first form.

An aspect of the present disclosure relates to a method for generating a data processing model. The method may be implemented on a computing device having at least one storage device storing a set of instructions, and at least one processor in communication with the at least one storage device. The method may include obtaining a training sample set including a plurality of training data pairs. Each of the plurality of training data pairs may include sample data and reference data of a same sample subject, and the sample data may relate to a sample truncation artifact. The method may further include for each of the plurality of training data pairs, transforming sample data and reference data of the training data pair from a first form to a second form, and generating the data processing model by training, based on the training sample set including a plurality of training data pairs in the second form, a preliminary machine learning model. The data processing model may be configured to generate truncation artifact corrected data.

In some embodiments, the training, based on the training sample set including a plurality of training data pairs in the second form, a preliminary machine learning model may include one or more iterations, at least one current iteration of which may include for each of at least one training data pair in the training sample set, generating, based on sample data of the training data pair, predicted data using the preliminary machine learning model or an intermediate machine learning model determined in a prior iteration, determining, based on the predicted data and reference data of the training data pair, a value of a loss function, determining, based on the value of the loss function, whether a termination condition is satisfied in the current iteration, and in response to determining that the termination condition is satisfied in the current iteration, designating the preliminary machine learning model or the intermediate machine learning model as the data processing model.

In some embodiments, the generating the data processing model by training, based on the training sample set including a plurality of training data pairs in the second form, a preliminary machine learning model may include for each of the plurality of training data pairs, obtaining, based on sample data of the training data pair in the second form, second sample data of a region corresponding to the sample truncation artifact, and obtaining, based on reference data of the training data pair in the second form, second reference data corresponding to the second sample data, determining a second training sample set including a plurality of second training data pairs corresponding to the plurality of training data pairs, wherein each of the plurality of second training data pairs may include second sample data and corresponding second reference data, and generating the data processing model by training, based on the second training sample set, the preliminary machine learning model.

In some embodiments, the first form may include a Cartesian coordinate form.

In some embodiments, the second form may include a polar coordinate form.

In some embodiments, the training, based on the second training sample set, the preliminary machine learning model may include one or more iterations. At least one current iteration of the one or more iterations may include for each of at least one second training data pair in the second training sample set, generating, based on second sample data of the second training data pair, intermediate data in the second form using the preliminary machine learning model or an intermediate machine learning model determined in a prior iteration, wherein the intermediate data may be configured to correct the sample truncation artifact, and generating predicted data by combining the second sample data and the intermediate data. The at least one current iteration of the one or more iterations may further include determining, based on the predicted data and second reference data of the second training data pair, a value of a loss function, determining, based on the value of the loss function, whether a termination condition is satisfied in the current iteration, and in response to determining that the termination condition is satisfied in the current iteration, designating the preliminary machine learning model or the intermediate machine learning model as the data processing model.

In some embodiments, the sample data may include a sample image including the sample truncation artifact, and the reference data may include a reference image having no sample truncation artifact.

In some embodiments, the obtaining a training sample set including a plurality of training data pairs may include obtaining a plurality of initial images of a plurality of sample subjects acquired by an imaging device. The plurality of initial images may correspond to a first scan fan angle and have no truncation artifact. And the obtaining a training sample set including a plurality of training data pairs may further include for each of the plurality of initial images, determining a second scan fan angle less than the first scan fan angle such that at least a portion of the sample subject extends beyond a scan field of view (FOV) of the imaging device corresponding to the second scan fan angle, and generating raw data by performing, based on the initial image and the first scan fan angle, a forward projection, and generating, based on the raw data, a training data pair including a sample image and a reference image.

In some embodiments, the generating, based on the raw data, a training data pair including a sample image and a reference image may include generating modified data by removing, from the raw data, data corresponding to a difference scan fan angle between the first scan fan angle and the second scan fan angle, and generating the sample image by performing, based on the modified data, a backward projection.

In some embodiments, the generating, based on the raw data, a training data pair including a sample image and a reference image further may include designating the initial image as the reference image.

In some embodiments, the obtaining a training sample set including a plurality of training data pairs may include obtaining a plurality of initial images of a plurality of sample subjects acquired by an imaging device, the plurality of initial images having no truncation artifact, for each of the plurality of initial images, determining a first reconstruction center according to which the initial image is reconstructed, determining a second reconstruction center for the initial image, and generating raw data by performing, based on the initial image and the second reconstruction center, a forward projection. The second reconstruction center may be different from the first reconstruction center such that at least a portion of the sample subject extends beyond a scan field of view (FOV) of the imaging device. And the obtaining a training sample set including a plurality of training data pairs may further include generating a training data pair based on the raw data.

In some embodiments, the generating a training data pair based on the raw data may include generating the sample image by performing, based on the raw data, a backward projection.

In some embodiments, the generating a training data pair based on the raw data may include designating the initial image as the reference image.

In some embodiments, the sample data of each of the plurality of training data pairs may be in a form of raw data.

In some embodiments, the reference data may be in a form of a sample truncation artifact corrected image or sample imaging data corresponding to the sample truncation artifact corrected image.

A further aspect of the present disclosure relates to a method for generating a data processing model. The method may be implemented on a computing device having at least one storage device storing a set of instructions, and at least one processor in communication with the at least one storage device. The method may include obtaining a plurality of initial images of a plurality of sample subjects acquired by an imaging device. The plurality of initial images may correspond to a first scan fan angle and having no truncation artifact. The method may further include determining a training sample set including a plurality of sample image pairs based on the plurality of initial images by a process including, for each of the plurality of initial images, determining a second scan fan angle including an extended scan fan angle with respect to the first scan fan angle, generating raw data by performing, based on the initial image and the second scan fan angle, a forward projection, and generating, based on the raw data, a sample image pair including a sample image and a reference image. The method may further include generating the data processing model by training, based on the training sample set, a preliminary machine learning model.

In some embodiments, the generating, based on the raw data, a sample image pair including a sample image and a reference image may include generating modified data by removing data corresponding to the extended scan fan angle from the raw data, and generating the sample image by performing, based on the modified data, a backward projection.

In some embodiments, the generating, based on the raw data, a training data pair including a sample image and a reference image may further include determining the reference image by performing, based on the raw data, a backward projection.

In some embodiments, the training, based on the training sample set, a preliminary machine learning model may include one or more iterations, at least one current iteration of which may include for each of at least one sample image pair in the training sample set, generating, based on a sample image of the sample image pair, a predicted image using the preliminary machine learning model or an intermediate machine learning model determined in a prior iteration, determining, based on the predicted image and a reference image of the training data pair, a value of a loss function, determining, based on the value of the loss function, whether a termination condition is satisfied in the current iteration, and in response to determining that the termination condition is satisfied in the current iteration, designating the preliminary machine learning model or the intermediate machine learning model as the data processing model.

In some embodiments, the generating the data processing model by training, based on the training sample set, a preliminary machine learning model may include for each of the plurality of sample image pairs, transforming a sample image and a reference image of the sample image pair from a first form to a second form, and generating the data processing model by training, based on the training sample set including a plurality of sample image pairs in the second form, the preliminary machine learning model.

A further aspect of the present disclosure relates to a system for data processing. The system may include at least one storage medium including a set of instructions, and at least one processor in communication with the at least one storage medium. When executing the set of instructions, the at least one processor may be directed to cause the system to perform operations including obtaining first data of a subject acquired by an imaging device. The first data may relate to a truncation artifact. The at least one processor may be directed to cause the system to perform operations including transforming the first data from a first form to a second form, and generating, based on the first data in the second form, truncation artifact corrected data using a data processing model.

A further aspect of the present disclosure relates to a system for generating a data processing model. The system may include at least one storage medium including a set of instructions, and at least one processor in communication with the at least one storage medium. When executing the set of instructions, the at least one processor may be directed to cause the system to perform operations including obtaining a training sample set including a plurality of training data pairs. Each of the plurality of training data pairs may include sample data and reference data of a same sample subject, and the sample data may relate to a sample truncation artifact. The at least one processor may be directed to cause the system to perform operations including for each of the plurality of training data pairs, transforming sample data and reference data of the training data pair from a first form to a second form, and generating the data processing model by training, based on the training sample set including a plurality of training data pairs in the second form, a preliminary machine learning model. The data processing model may be configured to generate truncation artifact corrected data.

A further aspect of the present disclosure relates to a system for generating a data processing model. The system may include at least one storage medium including a set of instructions, and at least one processor in communication with the at least one storage medium. When executing the set of instructions, the at least one processor may be directed to cause the system to perform operations including obtaining a plurality of initial images of a plurality of sample subjects acquired by an imaging device. The plurality of initial images may correspond to a first scan fan angle and have no truncation artifact. The at least one processor may be directed to cause the system to perform operations including determining a training sample set including a plurality of sample image pairs based on the plurality of initial images by a process including, for each of the plurality of initial images, determining a second scan fan angle including an extended scan fan angle with respect to the first scan fan angle, generating raw data by performing, based on the initial image and the second scan fan angle, a forward projection, and generating, based on the raw data, a sample image pair including a sample image and a reference image. The at least one processor may be directed to cause the system further to perform operations including generating the data processing model by training, based on the training sample set, a preliminary machine learning model.

A further aspect of the present disclosure relates to a non-transitory computer readable medium, including executable instructions that, when executed by at least one processor, direct the at least one processor to perform a method. The method may include obtaining first data of a subject acquired by an imaging device. The first data may relate to a truncation artifact. The method may include transforming the first data from a first form to a second form, and generating, based on the first data in the second form, truncation artifact corrected data using a data processing model.

A further aspect of the present disclosure relates to a non-transitory computer readable medium, including executable instructions that, when executed by at least one processor, direct the at least one processor to perform a method. The method may include obtaining a training sample set including a plurality of training data pairs. Each of the plurality of training data pairs may include sample data and reference data of a same sample subject, and the sample data may relate to a sample truncation artifact. The method may include for each of the plurality of training data pairs, transforming sample data and reference data of the training data pair from a first form to a second form, and generating the data processing model by training, based on the training sample set including a plurality of training data pairs in the second form, a preliminary machine learning model. The data processing model may be configured to generate truncation artifact corrected data.

A further aspect of the present disclosure relates to a non-transitory computer readable medium, including executable instructions that, when executed by at least one processor, direct the at least one processor to perform a method. The method may include obtaining a plurality of initial images of a plurality of sample subjects acquired by an imaging device. The plurality of initial images may correspond to a first scan fan angle and have no truncation artifact. The method may include determining a training sample set including a plurality of sample image pairs based on the plurality of initial images by a process including, for each of the plurality of initial images, determining a second scan fan angle including an extended scan fan angle with respect to the first scan fan angle, generating raw data by performing, based on the initial image and the second scan fan angle, a forward projection, and generating, based on the raw data, a sample image pair including a sample image and a reference image. The method may further include generating the data processing model by training, based on the training sample set, a preliminary machine learning model.

Additional features will be set forth in part in the description which follows, and in part will become apparent to those skilled in the art upon examination of the following and the accompanying drawings or may be learned by production or operation of the examples. The features of the present disclosure may be realized and attained by practice or use of various aspects of the methodologies, instrumentalities and combinations set forth in the detailed examples discussed below.

### BRIEF DESCRIPTION OF THE DRAWINGS

The present disclosure is further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1 is a schematic diagram illustrating an exemplary imaging system according to some embodiments of the present disclosure;

FIG. 2 is a schematic diagram illustrating exemplary hardware and/or software components of a computing device according to some embodiments of the present disclosure;

FIG. 3 is a schematic diagram illustrating exemplary hardware and/or software components of a mobile device according to some embodiments of the present disclosure;

FIGS. 4A and 4B are block diagrams illustrating exemplary processing devices according to some embodiments of the present disclosure;

FIG. 5 is a flowchart illustrating an exemplary process for data processing according to some embodiments of the present disclosure;

FIG. 6A is a flowchart illustrating an exemplary process for generating truncation artifact corrected data according to some embodiments of the present disclosure;

FIG. 6B is a schematic diagram illustrating an exemplary process for obtaining a second data according to some embodiments of the present disclosure;

FIG. 7 is a schematic diagram illustrating an exemplary application of a data processing model for generating a truncation artifact corrected image according to some embodiments of the present disclosure

FIG. 8 is a flowchart illustrating an exemplary process for generating a data processing model according to some embodiments of the present disclosure;

FIG. 9 is a flowchart illustrating an exemplary process for generating a data processing model according to some embodiments of the present disclosure;

FIG. 10 is a schematic diagram illustrating an exemplary simulated scan corresponding to a forward projection according to some embodiments of the present disclosure;

FIG. 11 is a flowchart illustrating an exemplary process for obtaining a training sample set according to some embodiments of the present disclosure;

FIG. 12 is a schematic diagram illustrating an exemplary simulated scan corresponding to a forward projection according to some embodiments of the present disclosure;

FIG. 13 is a flowchart illustrating an exemplary process for generating a data processing model according to some embodiments of the present disclosure;

FIG. 14 is a flowchart illustrating an exemplary process for training a preliminary machine learning model based on a second training sample set according to some embodiments of the present disclosure; and

FIG. 15 is a schematic diagram illustrating an exemplary training process of a preliminary machine learning model according to some embodiments of the present disclosure.

### DETAILED DESCRIPTION

In the following detailed description, numerous specific details are set forth by way of examples in order to provide a thorough understanding of the relevant disclosure. However, it should be apparent to those skilled in the art that the present disclosure may be practiced without such details. In other instances, well-known methods, procedures, systems, components, and/or circuitry have been described at a relatively high-level, without detail, in order to avoid unnecessarily obscuring aspects of the present disclosure. Various modifications to the disclosed embodiments will be readily apparent to those skilled in the art, and the general principles defined herein may be applied to other embodiments and applications without departing from the spirit and scope of the present disclosure. Thus, the present disclosure is not limited to the embodiments shown, but to be accorded the widest scope consistent with the claims.

The terminology used herein is for the purpose of describing particular example embodiments only and is not intended to be limiting. As used herein, the singular forms “a,” “an,” and “the” may be intended to include the plural forms as well, unless the context clearly indicates otherwise. It will be further understood that the terms “comprise,” “comprises,” and/or “comprising,” “include,” “includes,” and/or “including,” when used in this disclosure, specify the presence of stated features, integers, steps, operations, elements, and/or components, but do not preclude the presence or addition of one or more other features, integers, steps, operations, elements, components, and/or groups thereof.

It will be understood that the terms “system,” “engine,” “unit,” “module,” and/or “block” used herein are one method to distinguish different components, elements, parts, sections, or assemblies of different levels in ascending order. However, the terms may be displaced by another expression if they achieve the same purpose.

Generally, the word “module,” “unit,” or “block,” as used herein, refers to logic embodied in hardware or firmware, or to a collection of software instructions. A module, a unit, or a block described herein may be implemented as software and/or hardware and may be stored in any type of non-transitory computer-readable medium or other storage device. In some embodiments, a software module/unit/block may be compiled and linked into an executable program. It will be appreciated that software modules can be callable from other modules/units/blocks or from themselves, and/or may be invoked in response to detected events or interrupts. Software modules/units/blocks configured for execution on computing devices may be provided on a computer readable medium, such as a compact disc, a digital video disc, a flash drive, a magnetic disc, or any other tangible medium, or as a digital download (and can be originally stored in a compressed or installable format that needs installation, decompression, or decryption prior to execution). Such software code may be stored, partially or fully, on a storage device of the executing computing device, for execution by the computing device. Software instructions may be embedded in firmware, such as an EPROM. It will be further appreciated that hardware modules (or units or blocks) may be included in connected logic components, such as gates and flip-flops, and/or can be included in programmable units, such as programmable gate arrays or processors. The modules (or units or blocks) or computing device functionality described herein may be implemented as software modules (or units or blocks), but may be represented in hardware or firmware. In general, the modules (or units or blocks) described herein refer to logical modules (or units or blocks) that may be combined with other modules (or units or blocks) or divided into sub-modules (or sub-units or sub-blocks) despite their physical organization or storage.

It will be understood that when a unit, engine, module, or block is referred to as being “on,” “connected to,” or “coupled to” another unit, engine, module, or block, it may be directly on, connected or coupled to, or communicate with the other unit, engine, module, or block, or an intervening unit, engine, module, or block may be present, unless the context clearly indicates otherwise. As used herein, the term “and/or” includes any and all combinations of one or more of the associated listed items.

The terminology used herein is for the purposes of describing particular examples and embodiments only and is not intended to be limiting. As used herein, the singular forms “a,” “an,” and “the” may be intended to include the plural forms as well, unless the context clearly indicates otherwise. It will be further understood that the terms “include” and/or “comprise,” when used in this disclosure, specify the presence of integers, devices, behaviors, stated features, steps, elements, operations, and/or components, but do not exclude the presence or addition of one or more other integers, devices, behaviors, features, steps, elements, operations, components, and/or groups thereof.

Spatial and functional relationships between elements are described using various terms, including “connected,” “engaged,” “interfaced,” and “coupled.” Unless explicitly described as being “direct,” when a relationship between first and second elements is described in the present disclosure, that relationship includes a direct relationship where no other intervening elements are present between the first and second elements, and also an indirect relationship where one or more intervening elements are present (either spatially or functionally) between the first and second elements. In contrast, when an element is referred to as being “directly” connected, engaged, interfaced, or coupled to another element, there are no intervening elements present. In addition, a spatial and functional relationship between elements may be achieved in various ways. For example, a mechanical connection between two elements may include a welded connection, a key connection, a pin connection, an interference fit connection, or the like, or any combination thereof. Other words used to describe the relationship between elements should be interpreted in a like fashion (e.g., “between,” versus “directly between,” “adjacent,” versus “directly adjacent,” etc.).

These and other features, and characteristics of the present disclosure, as well as the methods of operation and functions of the related elements of structure and the combination of parts and economies of manufacture, may become more apparent upon consideration of the following description with reference to the accompanying drawings, all of which form a part of this disclosure. It is to be expressly understood, however, that the drawings are for the purpose of illustration and description only and are not intended to limit the scope of the present disclosure. It is understood that the drawings are not to scale.

As used herein, a representation of a subject (e.g., a patient, or a portion thereof) in an image may be referred to as the subject for brevity. For instance, a representation of an organ or tissue (e.g., the heart, the liver, a lung, etc., of a patient) in an image may be referred to as the organ or tissue for brevity. An image including a representation of a subject may be referred to as an image of the subject or an image including the subject for brevity. As used herein, an operation on a representation of a subject in an image may be referred to as an operation on the subject for brevity. For instance, a supplement to a portion of an image including a representation of an organ or tissue (e.g., the heart, the liver, a lung, etc., of a patient) may be referred to as a supplement to the organ or tissue for brevity.

An aspect of the present disclosure relates to systems and methods for data processing. The systems and methods may obtain first data of a subject acquired by an imaging device. The first data may relate to a truncation artifact. As used herein, the first data may be in a form of raw data or include a first image acquired by the imaging device, or a first image generated by way of image reconstruction based on the raw data. The systems and methods may further transform the first data from a first form (e.g., a Cartesian coordinate form) to a second form (e.g., a polar coordinate form). The systems and methods may further generate, based on the first data in the second form, truncation artifact corrected data using a data processing model.

According to some embodiments of the present disclosure, the first data relating to the truncation artifact may be processed using the data processing model. The data processing model may be a trained machine learning model (e.g., a trained neural network model) for correcting the truncation artifact in the first data. In the truncation artifact corrected data, data corresponding to the truncation artifact may be corrected or removed, and data relating to a portion of the subject that is obstructed or extends beyond a scan FOV of the imaging device may be improved or supplemented. In such cases, the truncation artifact corrected data may be generated, which may provide an image whose truncation artifact is corrected and that includes image data (or a corresponding image) having improved or complete information of the subject. According to some embodiments of the present disclosure, the first data may be transformed from a first form to a second form. The first data in the second form may be used to generate the truncation artifact corrected data. In some embodiments, data in the second form may be easier to process, which may improve the efficiency of the data processing.

According to another aspect of the present disclosure, a data processing model may be generated by training, based on the training sample set, a preliminary machine learning model. The training sample set may include a plurality of training data pairs. Each of the plurality of training data pairs may include sample data and reference data of a same sample subject. The sample data may relate to a truncation artifact. The data processing model may be configured to generate truncation artifact corrected data.

According to some embodiments of the present disclosure, the training sample set may be generated according to a simulation process performed based on one or more initial images deemed to have no truncation artifact. This may obviate the need of performing multiple actual scans on one or more sample subjects to obtain training samples, thereby improving the efficiency of determining a trained machine learning model. Additionally, a large amount of sample data may be obtained according to the simulation process, which may improve the accuracy of the trained machine learning model. According to some embodiments of the present disclosure, to train the preliminary machine learning model, the sample data and the reference data may be transformed from a first form (e.g., a Cartesian coordinate form) to a second form (e.g., a polar coordinate form). In some embodiments, data in the second form may be easier to process, which may improve the efficiency of the training of the preliminary machine learning model. Further, second sample data of a region corresponding to the truncation artifact may be obtained based on the sample data in the second form. Second reference data corresponding to the second sample data may be obtained based on the reference data in the second form. For each training data pair, the second sample data and the second reference data, instead of the sample data and the reference data, respectively, may be used to train the preliminary machine learning model. By using only a portion of the sample data and the reference data, respectively, that correspond to the truncation artifact where the truncation information is present, the amount of data to be processed in the model training may be reduced, thereby improving the efficiency of training the preliminary machine learning model.

The machine learning model (e.g., data processing model) so trained may be used to generate, based on an image (e.g., a first image) including a truncation artifact, a truncation artifact corrected image by performing a truncation artifact correction on only a portion of the image that corresponds to the truncation artifact where the truncation information is present and combine the truncation artifact corrected portion with the remaining portion of the image. By reducing the size of the image to be processed in the truncation artifact correction, the efficiency of the truncation artifact correction using the trained machine learning model may be improved. In some embodiments, the image may be transformed from a first form to a second form (e.g., from a Cartesian coordinate form to a polar coordinate form) to make it easier to process the image, e.g., extracting the portion the image that corresponds to the truncation artifact where the truncation information is present from the image for truncation artifact correction, combining the truncation artifact corrected portion with the remaining portion of the image, thereby further improving the efficiency of the truncation artifact correction.

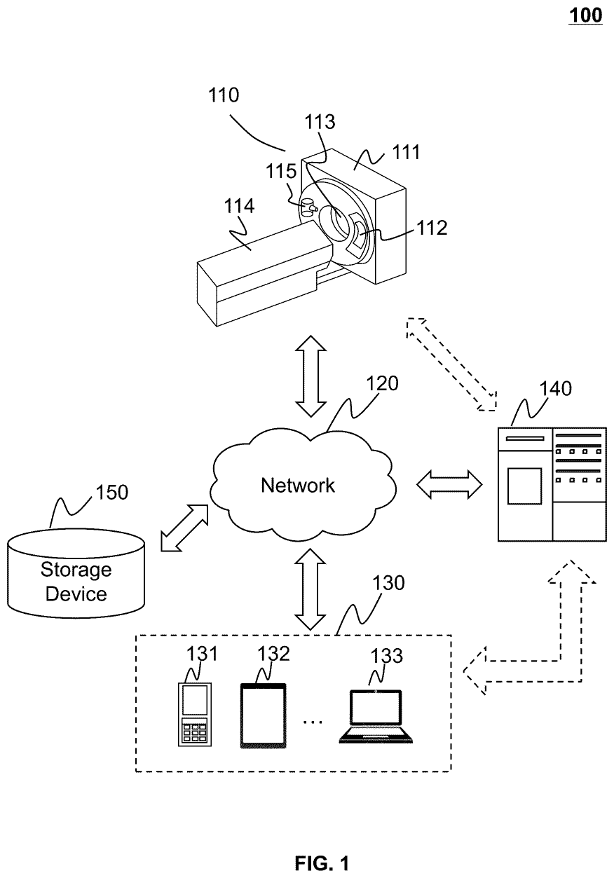

FIG. 1 is a schematic diagram illustrating an exemplary imaging system 100 according to some embodiments of the present disclosure. As shown, the imaging system 100 may include a medical imaging device 110, a network 120, one or more terminals 130, a processing device 140, a storage device 150. In some embodiments, the medical imaging device 110, the terminal(s) 130, the processing device 140, and/or the storage device 150 may be connected to and/or communicate with each other via a wireless connection, a wired connection, or a combination thereof. The connection between the components of the imaging system 100 may be variable. Merely by way of example, the medical imaging device 110 may be connected to the processing device 140 through the network 120 or directly. As a further example, the storage device 150 may be connected to the processing device 140 through the network 120 or directly.

The medical imaging device 110 may generate or provide image data related to an object via scanning the object. In some embodiments, the object may include a biological object and/or a non-biological object. For example, the object may include a specific portion of a body, such as a head, a thorax, an abdomen, or the like, or a combination thereof. In some embodiments, the medical imaging device 110 may include a single-modality scanner (e.g., a CT scanner, a magnetic resonance imaging (MRI) scanner) and/or multi-modality scanner (e.g., a PET-CT scanner) as described elsewhere in this disclosure. In some embodiments, the image data relating to the object may include projection data, one or more images of the object, etc. The projection data may include raw data generated by the medical imaging device 110 by scanning the object and/or data generated by a forward projection on an image of the object.

In some embodiments, the medical imaging device 110 may include a gantry 111, a detector 112, a detection region 113, a scanning table 114, and a radioactive scanning source 115. The gantry 111 may support the detector 112 and the radioactive scanning source 115. The object may be placed on the scanning table 114 and moved into the detection region 113 to be scanned. The radioactive scanning source 115 may emit radioactive rays to the object. The radioactive rays may include a particle ray, a photon ray, or the like, or a combination thereof. In some embodiments, the radioactive rays may include a plurality of radiation particles (e.g., neutrons, protons, electron, μ-mesons, heavy ions), a plurality of radiation photons (e.g., X-ray, a γ-ray, ultraviolet, laser), or the like, or a combination thereof. The detector 112 may detect radiations and/or radiation events (e.g., gamma photons) emitted from the detection region 113. In some embodiments, the detector 112 may include a plurality of detector units. The detector units may include a scintillation detector (e.g., a cesium iodide detector) or a gas detector. The detector unit may be a single-row detector or a multi-rows detector.

In some embodiments, a region where an imaging medium may reach and be detected by a detector (e.g., the detector 112) of an imaging device (e.g., the medical imaging device 110) during an imaging of the object using the imaging device may be referred to as a scan FOV of the imaging device. As used herein, an imaging medium refers to a medium that impinges on (and is reflected by or traverses) an object for imaging purposes; signals generated due to at least a portion of the imaging medium impinging on (e.g., reflected by or traversing) the object detected by a detector of an imaging device may provide information (e.g., anatomical and/or functional information) of the object. An imaging medium involved in an imaging may be generated by an imaging source of an imaging device. For instance, for a computed tomography (CT) scanner, the imaging medium may include x-rays generated by an x-ray source. In some embodiments, the object may be placed on the scanning table 114 and positioned in a certain range such that the object is completely within the scan FOV of the medical imaging device 110, or referred to as completely covered by the scan FOV. However, under some scanning conditions, at least a portion of the object may be obstructed or extend beyond the scan FOV. An obstruction may occur due to an imaging medium-impermeable item present in the pathway of the imaging medium that is between the imaging source and the object such that no (or negligible) imaging medium may impinge on the object, an imaging medium-impermeable item present in the pathway of the imaging medium that is between the object and the detector of the imaging device such that no (or negligible) imaging medium that is reflected or has traversed the object is detected by the detector, etc. Exemplary imaging medium-impermeable items may include a scanning table (e.g., the scanning table 114) on which the object is positioned for imaging, or a portion thereof. Correspondingly, image data relating to such a portion may be absent from the image data acquired by the medical imaging device 110, which may result in a truncation artifact in an image generated based on the image data so acquired.

The network 120 may include any suitable network that can facilitate the exchange of information and/or data for the imaging system 100. In some embodiments, one or more components of the imaging system 100 (e.g., the medical imaging device 110, the processing device 140, the storage device 150, the terminal(s) 130) may communicate information and/or data with one or more other components of the imaging system 100 via the network 120. For example, the processing device 140 may obtain image data from the medical imaging device 110 via the network 120. As another example, the processing device 140 may obtain user instruction(s) from the terminal(s) 130 via the network 120.

The network 120 may be or include a public network (e.g., the Internet), a private network (e.g., a local area network (LAN)), a wired network, a wireless network (e.g., an 802.11 network, a Wi-Fi network), a frame relay network, a virtual private network (VPN), a satellite network, a telephone network, routers, hubs, switches, server computers, and/or any combination thereof. For example, the network 120 may include a cable network, a wireline network, a fiber-optic network, a telecommunications network, an intranet, a wireless local area network (WLAN), a metropolitan area network (MAN), a public telephone switched network (PSTN), a Bluetooth™ network, a ZigBee™ network, a near field communication (NFC) network, or the like, or any combination thereof. In some embodiments, the network 120 may include one or more network access points. For example, the network 120 may include wired and/or wireless network access points such as base stations and/or internet exchange points through which one or more components of the imaging system 100 may be connected to the network 120 to exchange data and/or information.

The terminal(s) 130 may enable user interaction between a user and the imaging system 100. For example, the terminal(s) 130 may display an image including a truncation artifact. A user may select a region corresponding to the truncation artifact on the image. In some embodiments, the terminal(s) 130 may include a mobile device 131, a tablet computer 132, a laptop computer 133, or the like, or any combination thereof. For example, the mobile device 131 may include a mobile phone, a personal digital assistant (PDA), a gaming device, a navigation device, a point of sale (POS) device, a laptop, a tablet computer, a desktop, or the like, or any combination thereof. In some embodiments, the terminal(s) 130 may include an input device, an output device, etc. In some embodiments, the terminal(s) 130 may be part of the processing device 140.

The processing device 140 may process data and/or information obtained from the medical imaging device 110, the storage device 150, the terminal(s) 130, or other components of the imaging system 100. In some embodiments, the processing device 140 may be a single server or a server group. The server group may be centralized or distributed. For example, the processing device 140 may generate a model (e.g., data processing model) by training, based on a training sample set, a preliminary machine learning model. As another example, the processing device 140 may apply the model in, for example, generating truncation artifact corrected data. In some embodiments, the model may be generated by a processing device, while the application of the model may be performed on a different processing device. In some embodiments, the model may be generated by a processing device of a system other than the imaging system 100 or a processing device other than the processing device 140 on which the application of the model is performed. For instance, the model may be generated by a first system of a vendor who provides and/or maintains such model, while the generation of the truncation artifact corrected data using the provided model(s) may be performed on a second system of a client of the vendor. In some embodiments, the application of the model may be performed online in response to a request for, for example, generating the truncation artifact corrected data. In some embodiments, the model may be generated offline.

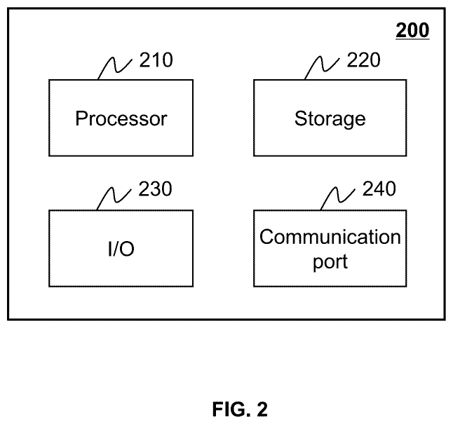

In some embodiments, the processing device 140 may be local to or remote from the imaging system 100. For example, the processing device 140 may access information and/or data from the medical imaging device 110, the storage device 150, and/or the terminal(s) 130 via the network 120. As another example, the processing device 140 may be directly connected to the medical imaging device 110, the terminal(s) 130, and/or the storage device 150 to access information and/or data. In some embodiments, the processing device 140 may be implemented on a cloud platform. For example, the cloud platform may include a private cloud, a public cloud, a hybrid cloud, a community cloud, a distributed cloud, an inter-cloud, a multi-cloud, or the like, or a combination thereof. In some embodiments, the processing device 140 may be implemented by a computing device 200 having one or more components as described in connection with FIG. 2.

In some embodiments, the processing device 140 may include one or more processors (e.g., single-core processor(s) or multi-core processor(s)). Merely by way of example, the processing device 140 may include a central processing unit (CPU), an application-specific integrated circuit (ASIC), an application-specific instruction-set processor (ASIP), a graphics processing unit (GPU), a physics processing unit (PPU), a digital signal processor (DSP), a field-programmable gate array (FPGA), a programmable logic device (PLD), a controller, a microcontroller unit, a reduced instruction-set computer (RISC), a microprocessor, or the like, or any combination thereof.

The storage device 150 may store data, instructions, and/or any other information. In some embodiments, the storage device 150 may store data obtained from the processing device 140, the terminal(s) 130, and/or the medical imaging device 110. In some embodiments, the storage device 150 may store data and/or instructions that the processing device 140 may execute or use to perform exemplary methods described in the present disclosure. In some embodiments, the storage device 150 may include a mass storage device, a removable storage device, a volatile read-and-write memory, a read-only memory (ROM), or the like, or any combination thereof. Exemplary mass storage devices may include a magnetic disk, an optical disk, a solid-state drive, etc. Exemplary removable storage devices may include a flash drive, a floppy disk, an optical disk, a memory card, a zip disk, a magnetic tape, etc. Exemplary volatile read-and-write memory may include a random access memory (RAM). Exemplary RAM may include a dynamic RAM (DRAM), a double date rate synchronous dynamic RAM (DDR SDRAM), a static RAM (SRAM), a thyristor RAM (T-RAM), and a zero-capacitor RAM (Z-RAM), etc. Exemplary ROM may include a mask ROM (MROM), a programmable ROM (PROM), an erasable programmable ROM (EPROM), an electrically erasable programmable ROM (EEPROM), a compact disk ROM (CD-ROM), and a digital versatile disk ROM, etc. In some embodiments, the storage device 150 may be implemented on a cloud platform as described elsewhere in the disclosure.

In some embodiments, the storage device 150 may be connected to the network 120 to communicate with one or more other components of the imaging system 100 (e.g., the processing device 140, the terminal(s) 130). One or more components of the imaging system 100 may access the data or instructions stored in the storage device 150 via the network 120. In some embodiments, the storage device 150 may be part of the processing device 140.

It should be noted that the above description of the imaging system 100 is intended to be illustrative, and not to limit the scope of the present disclosure. Many alternatives, modifications, and variations will be apparent to those skilled in the art. The features, structures, methods, and other characteristics of the exemplary embodiments described herein may be combined in various ways to obtain additional and/or alternative exemplary embodiments. For example, the imaging system 100 may include one or more additional components. Alternatively or additionally, one or more components of the imaging system 100, such as the medical imaging device 110 described above may be omitted. As another example, two or more components of the imaging system 100 may be integrated into a single component.

FIG. 2 is a schematic diagram illustrating exemplary hardware and/or software components of a computing device 200 according to some embodiments of the present disclosure. The computing device 200 may be used to implement any component of the imaging system 100 as described herein. For example, the processing device 140 and/or the terminal 130 may be implemented on the computing device 200, respectively, via its hardware, software program, firmware, or a combination thereof. Although only one such computing device is shown, for convenience, the computer functions relating to the imaging system 100 as described herein may be implemented in a distributed fashion on a number of similar platforms, to distribute the processing load. As illustrated in FIG. 2, the computing device 200 may include a processor 210, a storage 220, an input/output (I/O) 230, and a communication port 240.

The processor 210 may execute computer instructions (e.g., program code) and perform functions of the processing device 140 in accordance with techniques described herein. The computer instructions may include, for example, routines, programs, objects, components, data structures, procedures, modules, and functions, which perform particular functions described herein. For example, the processor 210 may process image data obtained from the medical imaging device 110, the terminal(s) 130, the storage device 150, and/or any other component of the imaging system 100. In some embodiments, the processor 210 may include one or more hardware processors, such as a microcontroller, a microprocessor, a reduced instruction set computer (RISC), an application specific integrated circuits (ASICs), an application-specific instruction-set processor (ASIP), a central processing unit (CPU), a graphics processing unit (GPU), a physics processing unit (PPU), a microcontroller unit, a digital signal processor (DSP), a field programmable gate array (FPGA), an advanced RISC machine (ARM), a programmable logic device (PLD), any circuit or processor capable of executing one or more functions, or the like, or any combinations thereof.

Merely for illustration, only one processor is described in the computing device 200. However, it should be noted that the computing device 200 in the present disclosure may also include multiple processors, thus operations and/or method operations that are performed by one processor as described in the present disclosure may also be jointly or separately performed by the multiple processors. For example, if in the present disclosure the processor of the computing device 200 executes both operation A and operation B, it should be understood that operation A and operation B may also be performed by two or more different processors jointly or separately in the computing device 200 (e.g., a first processor executes operation A and a second processor executes operation B, or the first and second processors jointly execute operations A and B).

The storage 220 may store data/information obtained from the medical imaging device 110, the terminal(s) 130, the storage device 150, and/or any other component of the imaging system 100. In some embodiments, the storage 220 may include a mass storage device, a removable storage device, a volatile read-and-write memory, a read-only memory (ROM), or the like, or any combination thereof. In some embodiments, the storage 220 may store one or more programs and/or instructions to perform exemplary methods described in the present disclosure. For example, the storage 220 may store a program for the processing device 140 to execute to generate an interest point detection model.

The I/O 230 may input and/or output signals, data, information, etc. In some embodiments, the I/O 230 may enable a user interaction with the processing device 140. In some embodiments, the I/O 230 may include an input device and an output device. The input device may include alphanumeric and other keys that may be input via a keyboard, a touch screen (for example, with haptics or tactile feedback), a speech input, an eye tracking input, a brain monitoring system, or any other comparable input mechanism. The input information received through the input device may be transmitted to another component (e.g., the processing device 140) via, for example, a bus, for further processing. Other types of the input device may include a cursor control device, such as a mouse, a trackball, or cursor direction keys, etc. The output device may include a display (e.g., a liquid crystal display (LCD), a light-emitting diode (LED)-based display, a flat panel display, a curved screen, a television device, a cathode ray tube (CRT), a touch screen), a speaker, a printer, or the like, or a combination thereof.

The communication port 240 may be connected to a network (e.g., the network 120) to facilitate data communications. The communication port 240 may establish connections between the processing device 140 and the medical imaging device 110, the terminal(s) 130, and/or the storage device 150. The connection may be a wired connection, a wireless connection, any other communication connection that can enable data transmission and/or reception, and/or any combination of these connections. The wired connection may include, for example, an electrical cable, an optical cable, a telephone wire, or the like, or any combination thereof. The wireless connection may include, for example, a Bluetooth™ link, a Wi-Fi™ link, a WiMax™ link, a WLAN link, a ZigBee™ link, a mobile network link (e.g., 3G, 4G, 5G), or the like, or a combination thereof. In some embodiments, the communication port 240 may be and/or include a standardized communication port, such as RS232, RS485, etc. In some embodiments, the communication port 240 may be a specially designed communication port. For example, the communication port 240 may be designed in accordance with the digital imaging and communications in medicine (DICOM) protocol.

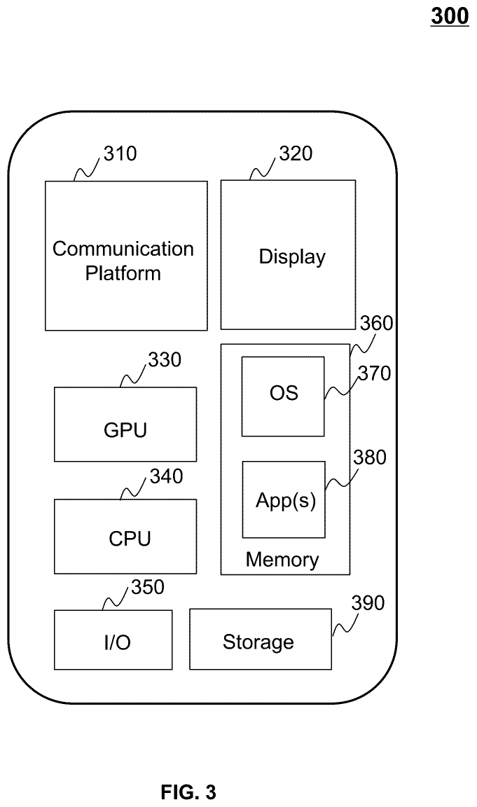

FIG. 3 is a schematic diagram illustrating exemplary hardware and/or software components of a mobile device 300 according to some embodiments of the present disclosure. In some embodiments, one or more components (e.g., a terminal 130 and/or the processing device 140) of the imaging system 100 may be implemented on the mobile device 300.

As illustrated in FIG. 3, the mobile device 300 may include a communication platform 310, a display 320, a graphics processing unit (GPU) 330, a central processing unit (CPU) 340, an I/O 350, a memory 360, and a storage 390. In some embodiments, any other suitable component, including but not limited to a system bus or a controller (not shown), may also be included in the mobile device 300. In some embodiments, a mobile operating system 370 (e.g., iOS™, Android™, Windows Phone™) and one or more applications 380 may be loaded into the memory 360 from the storage 390 in order to be executed by the CPU 340. The applications 380 may include a browser or any other suitable mobile apps for receiving and rendering information relating to image processing or other information from the processing device 140. User interactions with the information stream may be achieved via the I/O 350 and provided to the processing device 140 and/or other components of the imaging system 100 via the network 120.

To implement various modules, units, and their functionalities described in the present disclosure, computer hardware platforms may be used as the hardware platform(s) for one or more of the elements described herein. A computer with user interface elements may be used to implement a personal computer (PC) or any other type of work station or terminal device. A computer may also act as a server if appropriately programmed.

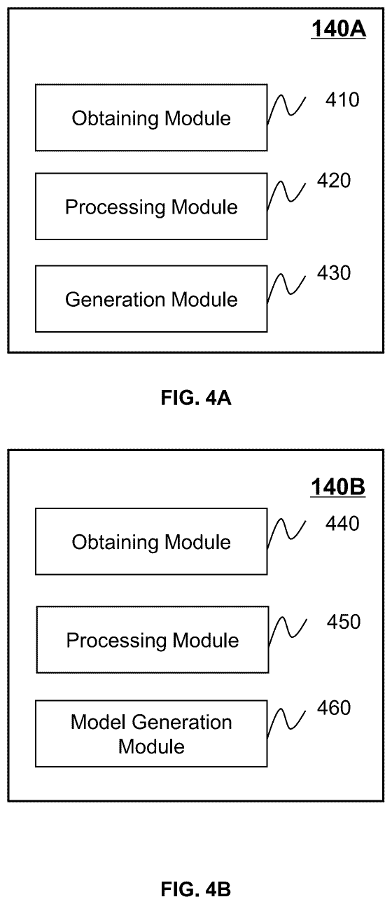

FIGS. 4A and 4B are block diagrams illustrating exemplary processing devices 140A and 140B according to some embodiments of the present disclosure. The processing devices 140A and 140B may be exemplary processing devices 140 as described in connection with FIG. 1. In some embodiments, the processing device 140A may be configured to apply a data processing model for generating truncation artifact corrected data. The processing device 140B may be configured to generate one or more training samples and/or generate one or more models (e.g., the data processing model) using the training samples. In some embodiments, the processing devices 140A and 140B may be respectively implemented on a processing unit (e.g., a processor 210 illustrated in FIG. 2 or a CPU 340 as illustrated in FIG. 3). Merely by way of example, the processing device 140A may be implemented on a CPU 340 of a terminal device, and the processing device 140B may be implemented on a computing device 200. Alternatively, the processing devices 140A and 140B may be implemented on a same computing device 200 or a same CPU 340. For example, the processing devices 140A and 140B may be implemented on a same computing device 200.

As shown in FIG. 4A, the processing device 140A may include an obtaining module 410, a processing module 420, and a generation module 430.

The obtaining module 410 may be configured to obtain first data of a subject acquired by an imaging device. In some embodiments, the first data may relate to a truncation artifact. In some embodiments, the first data may be in a form of raw data (e.g., projection data) acquired by the imaging device. In some embodiments, the first data may include a first image including a truncation artifact.

The processing module 420 may be configured to transform the first data from a first form (e.g., a Cartesian coordinate form) to a second form (e.g., a polar coordinate form). In some embodiments, the processing module 420 transform the first data from the first form to the second form using a transformation algorithm.

The generation module 430 may be configured to generate, based on the first data in the second form, truncation artifact corrected data using a data processing model. In some embodiments, the truncation artifact corrected data generated using the data processing model may be in the second form. The generation module 430 may be further configured to transform the truncation artifact corrected data from the second form to the first form. In some embodiments, to generate the truncation artifact corrected data using the data processing model, the generation module 430 may obtain, based on the first data in the second form, second data of a region corresponding to the truncation artifact. Further, the generation module 430 may generate, based on the first data and the second data, the truncation artifact corrected data using the data processing model. For example, the generation module 430 may generate, based on the second data, intermediate data in the second form. Further, the generation module 430 may generate the truncation artifact corrected data by combining the first data and the intermediate data. In some embodiments, to combine the first data and the intermediate data, the generation module 430 may obtain weighted intermediate data based on a weight. Further, the generation module 430 may transform the weighted intermediate data from the second form to the first form. Further, the generation module 430 may determine the truncation artifact corrected data by combining the first data and the weighted intermediate data both in the first form.

As shown in FIG. 4B, the processing device 140B may include an obtaining module 440, a processing module 450, and a model generation module 460.

The obtaining module 440 may be configured to obtain a training sample set including a plurality of training data pairs. Each of the plurality of training data pairs may include sample data and reference data of a same sample subject (e.g., a patient, an organ, a lesion, etc.). The sample data may relate to a truncation artifact. In some embodiments, the sample data may include a sample image including the sample truncation artifact, and the reference data may include a reference image having no sample truncation artifact. In some embodiments, the sample data of each of the plurality of training data pairs may be in a form of raw data. In some embodiments, the reference data may be in a form of a sample truncation artifact corrected image or sample imaging data corresponding to the sample truncation artifact corrected image.

In some embodiments, the sample image and/or the reference image may be obtained according to one or more simulation processes. For example, to obtain the training sample set, the obtaining module 440 may obtain a plurality of initial images of a plurality of sample subjects acquired by an imaging device. The plurality of initial images may correspond to a first scan fan angle and be deemed to have no truncation artifact. Further, for each of the plurality of initial images, the obtaining module 440 may determine a second scan fan angle including a scan fan angle with respect to the first scan fan angle. Further, the obtaining module 440 may generate raw data by performing, based on the initial image and the second scan fan angle, a forward projection. Further, the obtaining module 440 may generate, based on the raw data, a sample image pair including a sample image and a reference image. As another example, the obtaining module 440 may determine a third scan fan angle less than the first scan fan angle such that at least a portion of the sample subject may extend beyond a scan FOV of the imaging device corresponding to the third scan fan angle. Further, the obtaining module 440 may generate raw data by performing, based on the initial image and the first scan fan angle, a forward projection. Further, the obtaining module 440 may generate, based on the raw data, a sample image pair. As a further example, to obtain the training sample set, the obtaining module 440 may obtain a plurality of initial images of a plurality of sample subjects acquired by an imaging device. The plurality of initial images may be deemed to have no truncation artifact. For each of the plurality of initial images, the obtaining module 440 may determine a first reconstruction center according to which the initial image is reconstructed. The obtaining module 440 may determine a second reconstruction center for the initial image. The obtaining module 440 may generate raw data by performing, based on the initial image and the second reconstruction center, a forward projection. In some embodiments, the second reconstruction center may be different from the first reconstruction center such that at least a portion of the sample subject may extend beyond a scan FOV of the imaging device. Further, the obtaining module 440 may generate a training data pair based on the generated raw data.

The processing module 450 may be configured to transform sample data and reference data of the training data pair from the first form (e.g., a Cartesian coordinate form) to the second form (e.g., a polar coordinate form). In some embodiments, the processing module 450 may transform the sample data from the first form to the second form using a transformation algorithm.

The model generation module 460 may be configured to generate a data processing model by training, based on the training sample set including a plurality of training data pairs in the second form, a preliminary machine learning model. In some embodiments, the model generation module 460 may train, based on the training sample set, the preliminary machine learning model according to one or more iterations. In at least one current iteration, for each of at least one training data pair in the training sample set, the model generation module 460 may generate, based on sample data of the training data pair, predicted data using the preliminary machine learning model or an intermediate machine learning model determined in a prior iteration. Further, the model generation module 460 may determine, based on the predicted data and reference data of the training data pair, a value of a loss function, and determine, based on the value of the loss function, whether a termination condition is satisfied in the current iteration. Further, in response to determining that the termination condition is satisfied in the current iteration, the model generation module 460 may designate the preliminary machine learning model or the intermediate machine learning model as the data processing model.

It should be noted that the above description is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure. In some embodiments, the processing device 140A and/or the processing device 140B may share two or more of the modules, and any one of the modules may be divided into two or more units. For instance, the processing devices 140A and 140B may share a same obtaining module; that is, the obtaining module 410 and the obtaining module 430 are a same module. In some embodiments, the processing device 140A and/or the processing device 140B may include one or more additional modules, such a storage module (not shown) for storing data. In some embodiments, the processing device 140A and the processing device 140B may be integrated into one processing device 140.

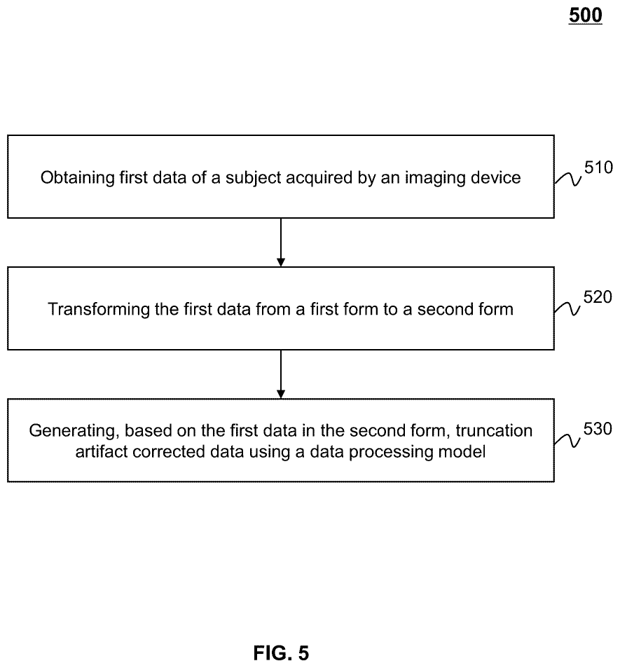

FIG. 5 is a flowchart illustrating an exemplary process for data processing according to some embodiments of the present disclosure. In some embodiments, process 500 may be executed by an imaging system (e.g., the imaging system 100). In some embodiments, the imaging system may be implemented by software and/or hardware. In some embodiments, at least part of process 500 may be performed by the processing device 140 (implemented in, for example, the computing device 200 shown in FIG. 2). For example, the process 500 may be stored in a storage device (e.g., the storage device 150, the storage 220, the storage 390) in the form of instructions (e.g., an application), and invoked and/or executed by the processing device 140 (e.g., the processor 210 illustrated in FIG. 2, the CPU 340 illustrated in FIG. 3, one or more modules illustrated in FIG. 4). The operations of the illustrated process presented below are intended to be illustrative. In some embodiments, the process 500 may be accomplished with one or more additional operations not described, and/or without one or more of the operations discussed. Additionally, the order in which the operations of the process 500 as illustrated in FIG. 5 and described below is not intended to be limiting. For illustration purposes, the following descriptions are described with reference to the implementation of the process 500 by the processing device 140A, and not intended to limit the scope of the present disclosure.

In 510, the processing device 140A (e.g., the obtaining module 410) may obtain first data of a subject acquired by an imaging device.

In some embodiments, the subject may include a patient, a man-made object, etc. In some embodiments, the subject may include a specific portion, organ, and/or tissue of a patient. For example, the subject may include a head, a brain, a neck, a body, a shoulder, an arm, a thorax, a cardiac, a stomach, a blood vessel, a soft tissue, a knee, feet, or the like, or any combination thereof.

In some embodiments, the first data may be acquired by the imaging device, such as the medical imaging device 110 of the imaging system 100, or an external imaging device. In some embodiments, the processing device 140A may obtain the first data from the imaging device. Alternatively, the first data may be acquired by the imaging device and stored in a storage device (e.g., the storage device 150, the storage 220, the storage 390, or an external source). The processing device 140A may retrieve the first data from the storage device.

In some embodiments, the first data may be in a form of raw data (e.g., projection data) acquired by the imaging device. For example, the first data may include a portion of projection data acquired by scanning the subject. As another example, the first data may include a portion of projection data selected from a plurality of directions. In some embodiments, the first data may include a first image including a truncation artifact. For example, the first image may include a reconstructed image generated based on raw data acquired by the imaging device. As another example, the first image may include a reconstructed image corrected using a preliminary correction algorithm.

In some embodiments, the first data may relate to a truncation artifact. Taking the first data in the form of the raw data as an example, during a scan of the subject, a portion of the subject may be obstructed by, for example, an (imaging medium-impermeable) item. In such cases, the raw data may lack data relating to the obstructed portion of the subject, which may result in the truncation artifact in an image (e.g., the first image) reconstructed based on the raw data. Taking the first data including the first image as another example, during a scan of the subject, a portion of the subject may extend beyond a scan FOV of the imaging device. Raw data acquired by the imaging device may be used to generate the first image. In such cases, the portion extending beyond the scan FOV may be left out in a scanning of the subject by the imaging device, which may result in data of the obstructed portion of the subject is missing in the raw data acquired in the scanning. The missing data may further result in the truncation artifact in the first image.

In 520, the processing device 140A (e.g., the processing module 420) may transform the first data from a first form to a second form.

In some embodiments, the first form may include a Cartesian coordinate form. In some embodiments, the second form may include a polar coordinate form. In some embodiments, the processing device 140A may transform the first data from the first form to the second form using a transformation algorithm. Exemplary transformation algorithms may include a Coordinate Rotation Digital Computer (CORDIC) algorithm, an algorithm based on transformation functions, or the like, or any combination thereof.

In some embodiments, the first data in the second form may be easier to process, which may improve the efficiency of the data processing. For example, the first data in the polar coordinate form may have a smaller volume than the first data in the Cartesian coordinate form. As another example, a region (e.g., a high-frequency region, such as a noise concentrated region, a region corresponding to bones of a patient, a region including a truncation artifact, etc.) of the first data (e.g., the first image) in the polar coordinate form may have a smaller area than the high-frequency region of the first data in the Cartesian coordinate form, which may improve the efficiency of data processing. As a further example, the first data in the polar coordinate form may have a circular shape, and a region corresponding to the truncation artifact in the first data may correspond to a ring-shaped region in the first data in the polar coordinate form (e.g., a ring-shaped region located at the outermost region of the circular shape), which may make a selection or extraction of a region corresponding to the truncation artifact more convenient.

In 530, the processing device 140A (e.g., the generation module 430) may generate, based on the first data in the second form, truncation artifact corrected data using a data processing model.

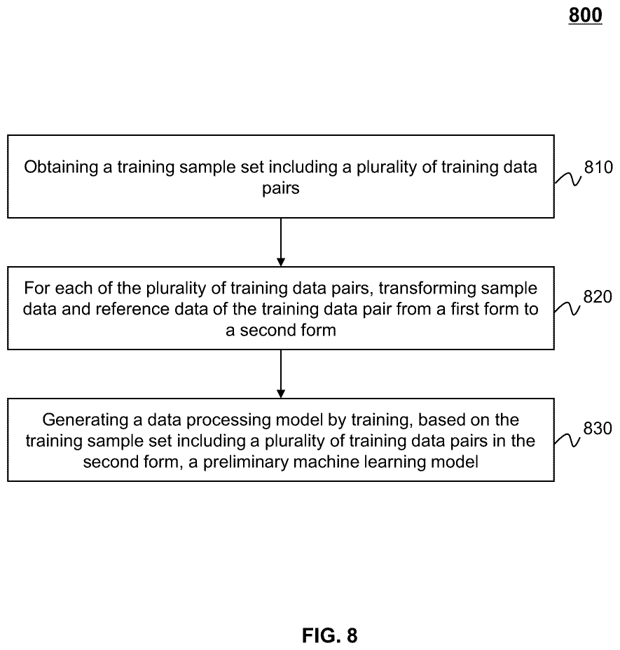

In some embodiments, the first data obtained in operation 510 may be input into the data processing model, and the data processing model may output the truncation artifact corrected data. In some embodiments, the data processing model may be obtained from one or more components of the imaging system 100 or an external source via a network (e.g., the network 120). For example, the data processing model may be previously trained by a computing device (e.g., the processing device 140B), and stored in a storage device (e.g., the storage device 150, the storage 220, and/or the storage 390) of the imaging system 100. The processing device 140A may access the storage device and retrieve the data processing model. In some embodiments, the data processing model may be generated by a computing device (e.g., the processing device 140B) by performing a process (e.g., process 800) for generating a data processing model disclosed herein. More descriptions regarding the generation of the data processing model may be found elsewhere in the present disclosure. See, e.g., FIG. 8 and relevant descriptions thereof. Alternatively or additionally, the data processing model may be generated and provided by a system of a vendor that provides and/or maintains such data processing model, wherein the system of the vendor is different from the imaging system 100. The processing device 140A may acquire the data processing model from the system of the vendor via a network (e.g., the network 120).

In some embodiments, the data processing model may be configured to correct the truncation artifact and improve or supplement the data relating to the portion(s) that is/are obstructed or extend beyond the scan FOV. In such cases, in the output of the data processing model, the truncation artifact may be corrected. Thus, the truncation artifact corrected data may include data having improved or complete information of the subject.

As used herein, data may be in the form of an image (e.g., an initial image, an image including a truncation artifact, a truncation artifact corrected image), or corresponding image data (e.g., raw data, first data, second data, artifact corrected data). For instance, the first data may be in the form of raw data. Correspondingly, the truncation artifact corrected data may be in a form of a truncation artifact corrected image or imaging data corresponding to the truncation artifact corrected image. In some embodiments, the first data may include the first image. Correspondingly, the truncation artifact corrected data may include a truncation artifact corrected image.

In some embodiments, the data processing model may generate truncation artifact corrected data in the second form based on the first data in the second form. The processing device 140A may further transform the truncation artifact corrected data from the second form to the first form. For example, the processing device 140A may transform the truncation artifact corrected data from the second form to the first form using a transformation algorithm. Exemplary transformation algorithms may include a Coordinate Rotation Digital Computer (CORDIC) algorithm, an algorithm based on transformation functions, or the like, or any combination thereof. The truncation artifact corrected data in the first form may be displayed to a user for further processing.

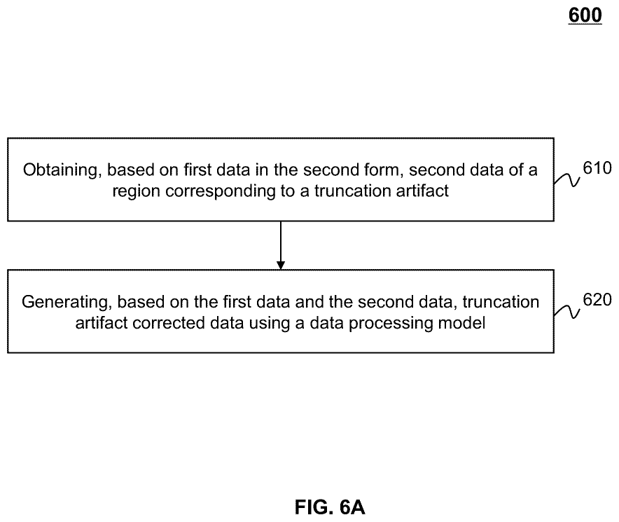

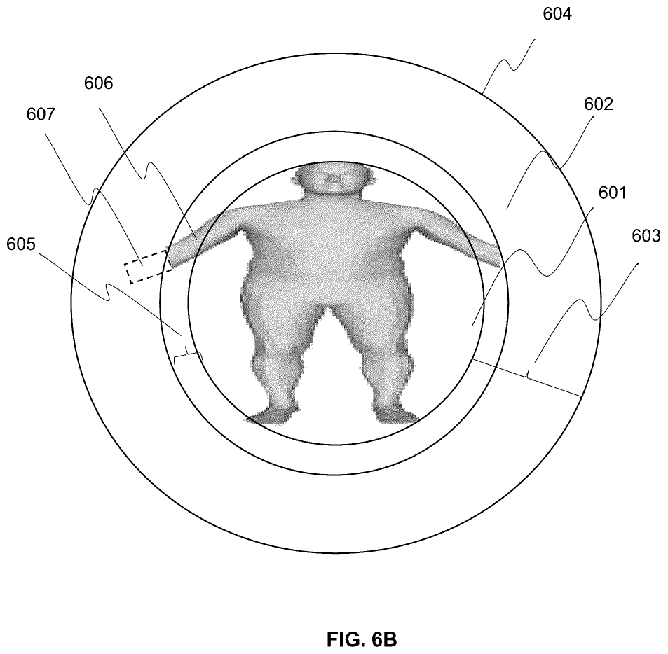

In some embodiments, to generate the truncation artifact corrected data using the data processing model, the processing device 140A may obtain, based on the first data in the second form, second data of a region corresponding to the truncation artifact. Further, the processing device 140A may generate, based on the first data and the second data, the truncation artifact corrected data using the data processing model. More descriptions regarding the generation of the truncation artifact corrected data may be found elsewhere in the present disclosure. See, e.g., FIG. 6A and relevant descriptions thereof.

It should be noted that the above description regarding the process 500 is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure. In some embodiments, the process 500 may be accomplished with one or more additional operations not described and/or without one or more of the operations discussed above. Additionally, the order of the process 500 may not be intended to be limiting. For example, the process 500 may include an operation for obtaining the data processing model by performing a process. As another example, operation 520 may be omitted. The processing device 140A may generate the truncation artifact corrected data based on the first data in the first form directly.

FIG. 6A is a flowchart illustrating an exemplary process for generating truncation artifact corrected data according to some embodiments of the present disclosure. In some embodiments, process 600 may be executed by an imaging system (e.g., the imaging system 100). In some embodiments, the imaging system may be implemented by software and/or hardware. In some embodiments, at least part of process 600 may be performed by the processing device 140 (implemented in, for example, the computing device 200 shown in FIG. 2). For example, the process 600 may be stored in a storage device (e.g., the storage device 150, the storage 220, the storage 390) in the form of instructions (e.g., an application), and invoked and/or executed by the processing device 140 (e.g., the processor 210 illustrated in FIG. 2, the CPU 340 illustrated in FIG. 3, one or more modules illustrated in FIG. 4). The operations of the illustrated process presented below are intended to be illustrative. In some embodiments, the process 600 may be accomplished with one or more additional operations not described, and/or without one or more of the operations discussed. Additionally, the order in which the operations of the process 600 as illustrated in FIG. 6A and described below is not intended to be limiting. In some embodiments, the operation 520 may be achieved according to the process 600. For illustration purposes, the following descriptions are described with reference to the implementation of the process 600 by the processing device 140A, and not intended to limit the scope of the present disclosure.

In 610, the processing device 140A (e.g., the generation module 430) may obtain, based on first data in a second form, second data of a region corresponding to the truncation artifact.

In some embodiments, to obtain the second data of the region corresponding to the truncation artifact, the processing device 140A may determine a first region inside a region of the truncation artifact (referred to as a truncated region for brevity). A first portion of a structure (e.g., a first portion 606 of an arm as illustrated in FIG. 6B) may be included in a difference region (i.e., the second difference region 605 illustrated in FIG. 6B) between an inside boundary of the truncated region and a boundary of the first region such that information of the first portion may be included in the second data to facilitate the correction of the truncation artifact relating to a second portion (e.g., 607 of the arm as illustrated in FIG. 6B) that is obstructed or extends beyond the scan FOV. Further, the processing device 140A may determine the region corresponding to the truncation artifact based on the first region. For example, the first data may be in a form of an image. The processing device 140A may determine a difference region between the boundary of the first region and a boundary of the image. Further, the processing device 140A may designate the difference region as the region corresponding to the truncation artifact. Assuming that region A and region B partially overlap and region A is larger than region B, a difference region between region A and region B refers to a region within region A that does not overlap any part of region B.

FIG. 6B is a schematic diagram illustrating an exemplary process for obtaining second data according to some embodiments of the present disclosure. For illustration purposes, the regions in FIG. 6B are expressed as circles corresponding to the polar coordinate form. In some embodiments, as illustrated in FIG. 6B, the first region 601 may be inside the truncated region 602. In such cases, the truncation artifact may be present in the difference region 603 between the boundary 604 of the image and the boundary of the first region 601. The difference region 603 may be designated as the region corresponding to the truncation artifact (i.e., the second data). In addition, since the first region 601 is inside the truncated region 602, the region corresponding to the truncation artifact may include a second difference region 605 between the inside boundary of the truncated region 602 and the boundary of the first region 601. The second difference region 605 may be used to facilitate the correction of the truncation artifact. For example, the second difference region 605 may include image data of a first portion 606 of a structure (e.g., an arm) of the subject. A second portion 607 of the structure may be obstructed or extend beyond the scan FOV of the imaging device, which may result in the truncation artifact in the truncated region 602. When generating, based on the second data, the truncation artifact corrected data, the data processing model may identify the first portion 606 of the structure in the second difference region 605. Further, the data processing model may generate, based on the identified structure, predicted data for correcting the truncation artifact and improving or supplementing data relating to the second portion 607 that is obstructed or extend beyond the scan FOV. In such cases, a truncation artifact corrected data may be obtained in which (a representation of) the structure of the subject is improved or supplemented to be complete.

Merely by way of example, the processing device 140A may determine a circle inside the region of the truncation artifact 602 as the first region 601, as illustrated in FIG. 6B. The area of the difference region between the region of the truncation artifact 602 and the first region 601 (i.e., an area of the second difference region 605) may be, for example, at least 1%, at least 2%, at least 5%, or at least 10%, etc., of the area of the region inside the truncated region 602, provided that a first portion of the structure is included in the second difference region 605. In some embodiments, the difference area may relate to a size of the first data (e.g., the first image). For example, the first data may be expressed in the form of a matrix (in the Cartesian coordinate form or the polar coordinate form). The size of an image used herein refers to a dimension (e.g., 256×256, 64×64, etc.) of the matrix. For example, for a first image having a relatively large size, the difference area may be relatively large. Correspondingly, the first region 601 may be relatively small. Alternatively or additionally, the difference area may be an empirical value predetermined by a user.

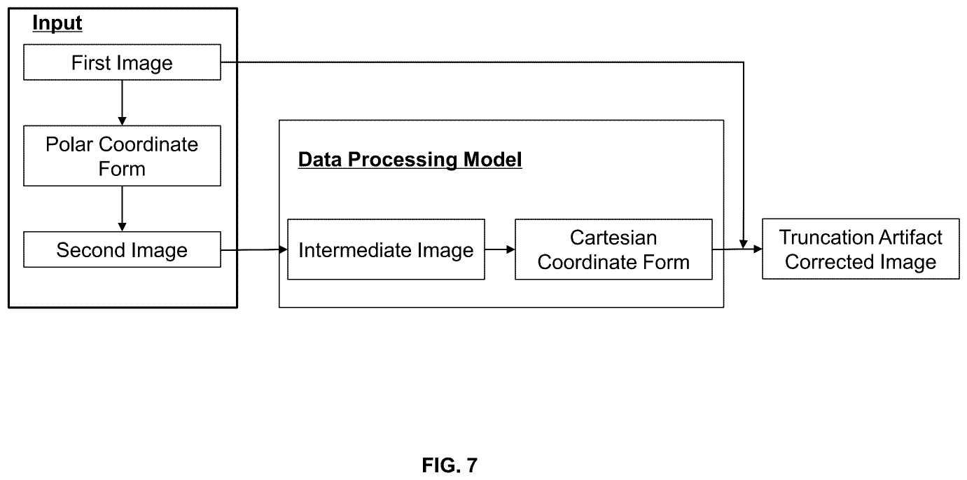

In some embodiments, the second data may mainly include the truncation artifact. For instance, at least 50%, or at least 60%, or at least 70%, or at least 80%, etc., of the area of the second data (e.g., a second image illustrated in FIG. 7) is deemed to include or be a truncation artifact. In such cases, when generating the truncation artifact corrected data, the data processing model may process the second data, instead of the entire first data. Compared with the processing of the entire first data, such methods may focus on the processing of the truncation artifact, which may improve the efficiency of truncation artifact correction by applying the data processing model.

In 620, the processing device 140A (e.g., the generation module 430) may generate, based on the first data and the second data, the truncation artifact corrected data using the data processing model.

In some embodiments, the first data and the second data may be input into the data processing model, and the data processing model may output the truncation artifact corrected data. In some embodiments, to generate, based on the first data and the second data, the truncation artifact corrected image using the data processing model, the processing device 140A may generate, based on the second data, intermediate data in the second form. Further, the processing device 140A may generate the truncation artifact corrected data by combining the first data and the intermediate data. In some embodiments, the intermediate data may be configured to correct the truncation artifact. Additionally, the intermediate data may also be configured to improve or supplement the data relating to one or more portions of the subject that are obstructed or extend beyond the scan FOV. In such cases, the truncation artifact may be corrected and the structure of the subject in the truncation artifact corrected data may be improved or supplemented to be complete.

In some embodiments, to combine the first data and the intermediate data, the processing device 140A may obtain weighted intermediate data based on a weight. The weight may relate to the intermediate data. For example, the weight and the intermediate data may be expressed in the form of a matrix, respectively. The matrix corresponding to the weight (referred to as weight matrix for brevity) may have a same dimension as the matrix corresponding to the intermediate data. Additionally, components at a same matrix position of the two matrices may correspond to each other. As used herein, two components from two different matrices are considered corresponding to each other if they correspond to a same physical point (e.g., a same point of the subject, a same point in space). In some embodiments, in a radial direction from the boundary of the first region to the boundary of the first data (e.g., an edge of the first image), a value of a component in the weight matrix may relate to a distance between the component and the boundary of the first region. For example, component A in the weight matrix may have a smaller value than component B if component A corresponds to a physical point closer to the boundary of the first region than component B. Further, the processing device 140A may transform the weighted intermediate data from the second form to the first form. Further, the processing device 140A may determine the truncation artifact corrected data by combining the first data and the weighted intermediate data both in the first form. In some embodiments, the intermediate data and the second data may have a same size. For example, the intermediate data and the second data may be expressed in the form of a matrix, respectively. The matrix corresponding to the intermediate data may have a same dimension as the matrix corresponding to the second data. Since the second data includes the image data corresponding to the second difference region between the boundary of the first region and the inside boundary of the region of the truncation artifact, the intermediate data determined on the basis of the second data may also include data corresponding to the second difference region. If the first data and the intermediate data are combined directly (without the weight), the data corresponding to the second difference region may influence the portion of the first data corresponding to the second difference region. For example, in the truncation artifact corrected data, the combination of the data corresponding to the second difference region and the portion of the first data corresponding to the second difference region may result in an abrupt change in the portion of the resultant truncation artifact corrected data corresponding to the boundary of the first region. The weight may be used to modulate the influence of the data corresponding to the second difference region on the truncation artifact corrected data. For example, in the radial direction from the boundary of the first region to the boundary of the first data (e.g., an edge of the first image), the weight may gradually transition from 0 to 1, thereby providing a smooth transition in the portion of the truncation artifact corrected data that corresponds to the boundary of the first region.

It should be noted that the above description regarding the process 600 is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure. In some embodiments, the process 600 may be accomplished with one or more additional operations not described and/or without one or more of the operations discussed above. Additionally, the order of the process 600 may not be intended to be limiting. For example, the process 600 may include an operation for transforming the first data from the first form to the second form.

FIG. 7 is a schematic diagram illustrating an exemplary application of a data processing model for generating a truncation artifact corrected image according to some embodiments of the present disclosure. As illustrated in FIG. 7, a first image may be transformed from a Cartesian coordinate form to a polar coordinate form. The first image may include a truncation artifact. Further, a second image may be obtained based on the first image in the polar coordinate form. The second image may be of a region corresponding to the truncation artifact. The first image and the second image may be input into a data processing model for generating a truncation artifact corrected image. In the data processing model, an intermediate image may be generated based on the second image. The intermediate image may include data for correcting the truncation artifact. Further, the intermediate image may be transformed from the polar coordinate form to the Cartesian coordinate. The data processing model may generate the truncation artifact corrected image by combining the first image and the intermediate image.

FIG. 8 is a flowchart illustrating an exemplary process for generating a data processing model according to some embodiments of the present disclosure. In some embodiments, process 800 may be executed by an imaging system (e.g., the imaging system 100). In some embodiments, the imaging system may be implemented by software and/or hardware. In some embodiments, at least part of process 800 may be performed by the processing device 140 (implemented in, for example, the computing device 200 shown in FIG. 2). For example, the process 800 may be stored in a storage device (e.g., the storage device 150, the storage 220, the storage 390) in the form of instructions (e.g., an application), and invoked and/or executed by the processing device 140 (e.g., the processor 210 illustrated in FIG. 2, the CPU 340 illustrated in FIG. 3, one or more modules illustrated in FIG. 4). The operations of the illustrated process presented below are intended to be illustrative. In some embodiments, the process 800 may be accomplished with one or more additional operations not described, and/or without one or more of the operations discussed. Additionally, the order in which the operations of the process 800 as illustrated in FIG. 8 and described below is not intended to be limiting. Alternatively, the process 800 may be performed by a computing device of a system of a vendor that provides and/or maintains such data processing model, wherein the system of the vendor is different from the imaging system 100. For illustration purposes, the following descriptions are described with reference to the implementation of the process 800 by the processing device 140B, and not intended to limit the scope of the present disclosure.

In 810, the processing device 140B (e.g., the obtaining module 440) may obtain a training sample set including a plurality of training data pairs.

Each of the plurality of training data pairs may include sample data and reference data of a same sample subject (e.g., a patient, an organ, a lesion, etc.). The sample data may relate to a truncation artifact. As described in connection with FIG. 5, one or more portions of the subject in the sample data may be obstructed or extend beyond a scan FOV of the imaging device, which may result in the truncation artifact in the sample data (e.g., a sample image). In the reference data, the sample subject may be completely covered by a scan FOV of an imaging device such that the sample subject may be fully scanned by the imaging device. In some embodiments, the sample data and the reference data of the sample subject may be actual scanning data acquired by an imaging of the sample subject. In some embodiments, the sample data or the reference data may be simulated data of the sample subject determined by simulation based on actual scanning data or simulated image data. In some embodiments, the training sample set may include training data pairs of actual scanning data, training data pairs of simulated data, or a combination thereof. In some embodiments, the training sample set may include training data pairs of data from a same sample subject, or different sample subjects.

In some embodiments, the sample data may be in a form of raw data. Correspondingly, the reference data may be in a form of raw data (or sample imaging data corresponding to a sample truncation artifact corrected image). For example, an imaging device (e.g., the medical imaging device 110) may acquire the sample data in the form of the raw data by scanning the sample subject using a first scan fan angle. And the imaging device may acquire the reference data in the form of the raw data by scanning the sample subject using a second scan fan angle. The first scan fan angle may correspond to a first scan FOV, and the second scan fan angle may correspond to a first scan FOV. The second scan fan angle may be larger than the first scan fan angle such that the sample subject may be completely covered by the second scan FOV. As another example, the imaging device may acquire the sample data and the reference data by scanning the sample subject using the second scan fan angle, while in the acquisition of the sample data, one or more portions of the sample subject in a difference region between the second scan FOV and the first scan FOV may be obstructed. In such cases, the sample data may be considered equivalent to that acquired by scanning the sample subject using the first scan fan angle. As a further example, the sample data and/or the reference data may be obtained according to one or more simulation processes.

In some embodiments, the sample data in the form of the raw data may be a portion of initial raw data (e.g., a layer of complete projection data) of the sample subject. Correspondingly, the reference data in the form of the raw data may be the initial raw data (e.g., the complete projection data). In some embodiments, the sample data may be a portion of the initial raw data selected from a plurality of directions. Correspondingly, the reference data may be the initial raw data (e.g., the complete projection data). As used herein, the plurality of directions may include any suitable direction, as long as the initial raw data in the selected direction includes data relating to the truncation artifact.

In some embodiments, the sample data may be in a form of raw data. Correspondingly, the reference data may include a reference image having no sample truncation artifact (or a sample truncation artifact corrected image).

In some embodiments, the sample data may include a sample image including the sample truncation artifact, and the reference data may include a reference image having no sample truncation artifact (or a sample truncation artifact corrected image). In some embodiments, the sample image and the reference image may be obtained in a similar manner as the obtaining of the sample data and the reference data in the form of the raw data. For example, after obtaining the sample data and the reference data in the form of the raw data, the processing device 140B may obtain the sample image and the reference image by performing a reconstruction operation.

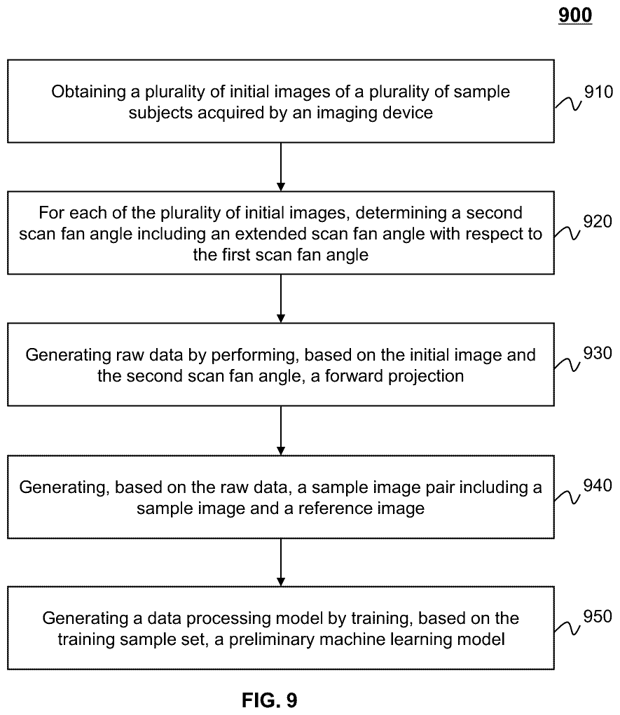

In some embodiments, the sample image and/or the reference image may be obtained according to one or more simulation processes. For example, to obtain the training sample set, the processing device 140B may obtain a plurality of initial images of a plurality of sample subjects acquired by an imaging device. The plurality of initial images may correspond to a first scan fan angle and be deemed to have no truncation artifact. Further, for each of the plurality of initial images, the processing device 140B may determine a second scan fan angle including a scan fan angle with respect to the first scan fan angle. Further, the processing device 140B may generate raw data by performing, based on the initial image and the second scan fan angle, a forward projection. Further, the processing device 140B may generate, based on the raw data, a sample image pair including a sample image and a reference image. More descriptions regarding the simulation process may be found elsewhere in the present disclosure. See, e.g., FIG. 9 and relevant descriptions thereof.

As another example, the processing device 140B may determine a third scan fan angle less than the first scan fan angle such that at least a portion of the sample subject may extend beyond a scan FOV of the imaging device corresponding to the third scan fan angle. Further, the processing device 140B may generate raw data by performing, based on the initial image and the first scan fan angle, a forward projection. Further, the processing device 140B may generate, based on the raw data, a sample image pair.

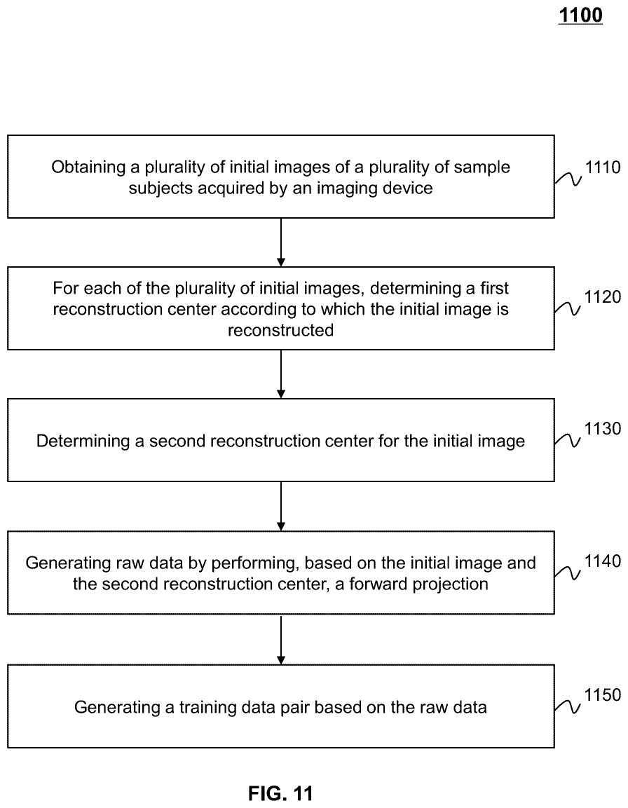

As another example, to obtain the training sample set, the processing device 140B may obtain a plurality of initial images of a plurality of sample subjects acquired by an imaging device. The plurality of initial images may be deemed to have no truncation artifact. For each of the plurality of initial images, the processing device 140B may determine a first reconstruction center according to which the initial image is reconstructed. The processing device 140B may determine a second reconstruction center for the initial image. The processing device 140B may generate raw data by performing, based on the initial image and the second reconstruction center, a forward projection. In some embodiments, the second reconstruction center may be different from the first reconstruction center such that at least a portion of the sample subject may extend beyond a scan FOV of the imaging device. Further, the processing device 140B may generate a training data pair based on the generated raw data. More descriptions regarding a simulation process for generating the training sample set may be found elsewhere in the present disclosure. See, e.g., FIG. 9, FIG. 11, and relevant descriptions thereof.

In 820, for each of the plurality of training data pairs, the processing device 140B (e.g., the processing module 450) may transform sample data and reference data of the training data pair from a first form to a second form.

In some embodiments, the first form may include a Cartesian coordinate form. In some embodiments, the second form may include a polar coordinate form. In some embodiments, the processing device 140B may transform the sample data from the first form to the second form using a transformation algorithm. Exemplary transformation algorithm may include a Coordinate Rotation Digital Computer (CORDIC) algorithm, an algorithm based on transformation functions, or the like, or any combination thereof.

In some embodiments, as described in connection with FIG. 5, the sample data and the reference data in the second form may be easier to process, which may improve the efficiency of generating the data processing model.

In 830, the processing device 140B (e.g., the model generation module 460) may generate a data processing model by training, based on the training sample set including a plurality of training data pairs in the second form, a preliminary machine learning model.

In some embodiments, the data processing model may be configured to generate truncation artifact corrected data. For example, first data including a truncation artifact (e.g., the first data described in connection with FIG. 5) may be input into the data processing model, and the data processing model may output the truncation artifact corrected data. In the truncation artifact corrected data, the truncation artifact in the first data may be corrected and data relating to one or more portions of the subject that are obstructed or extend beyond the scan FOV may be improved or supplemented.

In some embodiments, the preliminary machine learning model may include one or more model parameters having one or more initial values before model training. The training of the preliminary machine learning model may include one or more iterations. For illustration purposes, the following descriptions are described with reference to a current iteration. In the current iteration, the processing device 140B may input the sample data of a training data pair into the preliminary machine learning model (or an intermediate machine learning model obtained in a prior iteration (e.g., the immediately prior iteration)) in the current iteration to obtain predicted data (e.g., a predicted image). The processing device 140B may determine a value of a loss function based on the predicted data and the reference data of the training data pair. The loss function may be used to measure a difference between the predicted sample data and the reference data of the training data pair. The processing device 140B may determine whether a termination condition is satisfied in the current iteration based on the value of the loss function. Exemplary termination conditions may include that the value of the loss function obtained in the current iteration is less than a predetermined threshold, a certain count of iterations is performed, that the loss function converges such that the differences of the values of the loss function obtained in consecutive iterations are within a threshold, or the like, or any combination thereof. In response to a determination that the termination condition is satisfied in the current iteration, the processing device 140B may designate the preliminary machine learning model in the current iteration (or the intermediate machine learning model) as the data processing model. Alternatively or additionally, the processing device 140B may further store the data processing model into a storage device (e.g., the storage device 150, the storage 220, and/or the storage 390) of the imaging system 100 and/or output the data processing model for further use (e.g., in process 500 and/or process 600).

If the termination condition is not satisfied in the current iteration, the processing device 140B may update the preliminary machine learning model in the current iteration and proceed to a next iteration. For example, the processing device 140B may update the value(s) of the model parameter(s) of the preliminary machine learning model based on the value of the loss function according to, for example, a backpropagation algorithm. The processing device 140B may designate the updated preliminary machine learning model in the current iteration as a preliminary machine learning model in a next iteration. The processing device 140B may perform the next iteration until the termination condition is satisfied. After the termination condition is satisfied in a certain iteration, the preliminary machine learning model in the certain iteration may be designated as the data processing model.

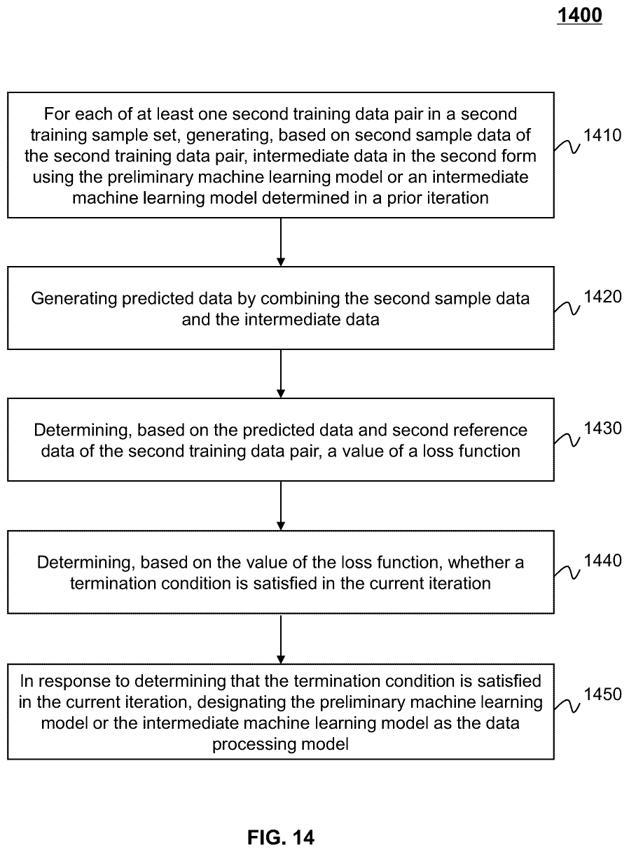

In some embodiments, the preliminary machine learning model may be trained according to a machine learning algorithm as described elsewhere in this disclosure. See, e.g., FIG. 14 and relevant descriptions thereof.

It should be noted that the above descriptions regarding the process 800 is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure. In some embodiments, the order of the process 800 and/or the process 800 may not be intended to be limiting. For example, the processing device 140B may test the data processing model using a set of testing samples to determine whether a testing condition is satisfied. If the testing condition is not satisfied, the process 800 may be performed again to further train the preliminary machine learning model. Alternatively or additionally, the plurality of training data pairs in the training sample set may include sample data and reference data of different sample subjects. For example, a training data pair may be of a first patient (or a first organ), and another training data pair may be of a second patient (or a second organ). As another example, a training data pair may be of an organ of a first patient, and another training data pair may be of a same organ of a second patient. As a further example, a training data pair may be of an organ of a first patient, and another training data pair may be of another organ of a second patient.

FIG. 9 is a flowchart illustrating an exemplary process for generating a data processing model according to some embodiments of the present disclosure. In some embodiments, process 900 may be executed by an imaging system (e.g., the imaging system 100). In some embodiments, the imaging system may be implemented by software and/or hardware. In some embodiments, at least part of process 900 may be performed by the processing device 140 (implemented in, for example, the computing device 200 shown in FIG. 2). For example, the process 900 may be stored in a storage device (e.g., the storage device 150, the storage 220, the storage 390) in the form of instructions (e.g., an application), and invoked and/or executed by the processing device 140 (e.g., the processor 210 illustrated in FIG. 2, the CPU 340 illustrated in FIG. 3, one or more modules illustrated in FIG. 4). The operations of the illustrated process presented below are intended to be illustrative. In some embodiments, the process 900 may be accomplished with one or more additional operations not described, and/or without one or more of the operations discussed. Additionally, the order in which the operations of the process 900 as illustrated in FIG. 9 and described below is not intended to be limiting. For illustration purposes, the following descriptions are described with reference to the implementation of the process 900 by the processing device 140B, and not intended to limit the scope of the present disclosure.

In 910, the processing device 140B (e.g., the obtaining module 440) may obtain an initial image of a sample subject acquired by an imaging device.

In some embodiments, the initial image may correspond to a first scan fan angle and be deemed to have no truncation artifact. For example, the imaging device (e.g., the medical imaging device 110) may acquire the initial image by scanning the sample subject using the first scan fan angle. For the initial image, the sample subject may be completely covered by the first scan fan angle such that the sample subject may be fully scanned. As used herein, an initial image deemed to have no truncation artifact refers to that the initial image is considered to have no truncation artifact or has no observable truncation artifact based on a truncation artifact detection method. Such a truncation artifact detection method may be performed automatically based on a truncation artifact detection algorithm, or manually by an operator (e.g., a physician, an imaging technician, etc.).

In some embodiments, the processing device 140B may obtain the initial image by causing the imaging device to scan the sample subject. In some embodiments, the initial image may be acquired in a scan of the sample subject using the imaging device and stored in a storage device (e.g., the storage device 150, the storage 220, and/or the storage 390). The processing device 140B may access the storage device and retrieve the initial image.

In 920, for the initial image, the processing device 140B (e.g., the obtaining module 440) may determine a second scan fan angle including an extended scan fan angle with respect to the first scan fan angle. In some embodiments, the second scan fan angle may be larger than the first scan fan angle. The extended scan fan angle may refer to a difference region between the first scan fan angle and the second scan fan angle.

In 930, the processing device 140B (e.g., the obtaining module 440) may generate raw data by performing, based on the initial image and the second scan fan angle, a forward projection.

During the forward projection, a reconstruction center of the initial image may be adjusted such that a portion of the sample subject may extend beyond the first scan fan angle and move into the extended scan fan angle. That is, the initial image may be obtained by performing an actual scan on the sample subject using the first scan fan angle. In the actual scan, the sample subject may be completely covered by the first scan fan angle. The forward projection may be performed to simulate a scan on the sample subject using the second scan fan angle. In the simulated scan, the sample subject may be moved relative to an original position in the actual scan (which may be equivalent to that a scanning source (e.g., the radioactive scanning source 115 in FIG. 1) is moved relative to an original position in the actual scan) such that a portion of the sample subject may extend into the extended scan fan angle.

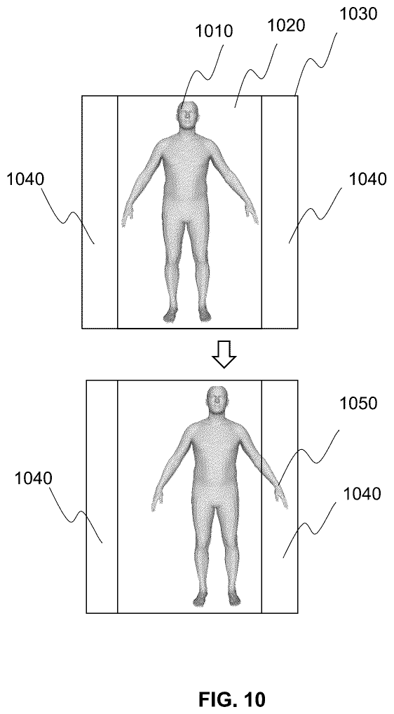

FIG. 10 is a schematic diagram illustrating an exemplary simulated scan corresponding to the forward projection according to some embodiments of the present disclosure. As illustrated in FIG. 10, during an actual scan, a sample subject 1010 may be completely covered by the first scan fan angle 1020. An initial image obtained in the actual scan may correspond to the first scan fan angle 1020 and be deemed to have no truncation artifact. To generate the raw data, a second scan fan angle 1030 may be determined. The second scan fan angle 1030 may include an extended scan fan angle 1040 with respect to the first scan fan angle 1020. In the simulated scan corresponding to the forward projection, the sample subject 1010 may be moved (or a scanning source is moved) such that a portion 1050 of the sample subject 1010 may move into the extended scan fan angle 1040. Simulated raw data corresponding to the second scan fan angle 1030 may be obtained.

In 940, the processing device 140B (e.g., the obtaining module 440) may generate, based on the raw data, a sample image pair including a sample image and a reference image.

In some embodiments, to generate, based on the raw data, the training data pair including the sample image and the reference image, the processing device 140B may generate modified data by removing data corresponding to the extended scan fan angle from the raw data. For example, as shown in FIG. 10, the portion 1050 of the sample subject 1010 may be moved into the extended scan fan angle 1040 by moving the initial image of the sample subject 1010. Correspondingly, the data corresponding to the extended scan fan angle 1040 in the raw data may relate to the portion 1050. The processing device 140B may remove the data relating to the portion 1050 from the raw data, for example, by removing the data corresponding to the extended scan fan angle 1040. The processing device 140B may generate the sample image by performing, based on the modified data, a backward projection. Further, the processing device 140B may determine the reference image by performing, based on the raw data, a backward projection. In some embodiments, both the backward projection for generating the sample image and the backward projection for generating the reference image may be performed according to the second scan fan angle. In such cases, the sample image and the reference image may have a same size. For example, the sample image and the reference image may be expressed in the form of a matrix, respectively. The matrix corresponding to the sample image may have a same dimension as the matrix corresponding to the reference image. Additionally, elements (e.g., pixels, or voxels) in a same matrix position of the two matrices, or referred to as corresponding elements, may correspond to a same position of the sample subject.

In some embodiments, since the data relating to the portion 1050 is removed from the raw data to obtain the modified data, the data relating to the portion 1050 may be referred to as missing data. Correspondingly, the modified data may be considered to be truncated. In such cases, when the sample image is generated by performing, based on the modified data, the backward projection, a truncation artifact may be introduced into the sample image. The truncation artifact may correspond to the extended scan fan angle 1040. And data relating to the sample subject 1010 in the sample image may be equivalent to be acquired by scanning the sample subject 1010 using the first scan fan angle 1020. In some embodiments, since the sample subject 1010 is completely covered by the second scan fan angle 1030, the raw data may include complete data of the sample subject 1010. In such cases, the reference image generated based on the raw data may be deemed to have no truncation artifact.

In some embodiments, exemplary backward projections performed by the processing device 140B may include a convolution back projection, a filtered back projection, or the like, or any combination thereof. In some embodiments, the back projection (e.g., the filtered back projection) may be sensitive to a truncation. For example, a filtering process in the filtered back projection may produce a sharp rise in the values of the elements (e.g., pixels, voxels) near where the truncation occurs, which may result in an artifact that appears as a white band in the sample image. The artifact that appears as a white band may be a portion of the truncation artifact. Moreover, the artifact may propagate towards the center of the sample image, degrading overall image quality. Thus, to generate the sample image by performing, based on the modified data, a backward projection, the processing device 140B may generate extrapolated data by performing, based on the modified data, an extrapolation operation. The processing device 140B may determine the sample image by performing, based on the extrapolated data, the backward projection. For instance, a data extrapolation operation may be a process in which the value of a specific element (e.g., an element in the extended scan fan angle) is estimated based on the values of elements in the vicinity of the specific element in space (e.g., an element in the first scan fan angle near the extended scan fan angle). In such cases, missing data in the extended scan fan angle may be supplemented by the extrapolation operation. The extrapolated data including the supplemented missing data may be considered as not truncated, which may eliminate or reduce the influence of the truncation on the back projection, thereby improving the image quality of the sample image.

In some embodiments, operations (e.g., operations 910-940) of the process 900 may be repeated to generate, based on a plurality of initial images, a training sample set including a plurality of training data pairs. In some embodiment, the plurality of initial images may be acquired by a same imaging device, or different imaging devices of a same type (e.g., initial images acquired using different CT scanners) or of different types (e.g., initial images acquired using at least one CT scanner and at least one PET scanner). Taking a training sample set including a plurality of initial images acquired by different imaging devices of different types as an example, the truncation artifacts corresponding to the different imaging devices of different types may be different. In such cases, a classification operation may be introduced into the training process of the preliminary machine learning model. For example, the preliminary machine learning model may include a classification network configured to classify the truncation artifacts. Further, the training process may be performed based on the classified truncation artifacts. In some embodiment, the plurality of initial images may be acquired by scanning a same sample subject in plurality of scans, or may be acquired by scanning different sample subjects. In some embodiment, the plurality of training data pairs may include a plurality of sample images corresponding to a first scan fan angle of a same size or different sizes. In some embodiment, the plurality of training data pairs may include a plurality of reference images corresponding to a second scan fan angle of a same size or different sizes.

In 950, the processing device 140B (e.g., the model generation module 460) may generate the data processing model by training, based on the training sample set, a preliminary machine learning model.

In some embodiment, the training of the preliminary machine learning model may include one or more iterations. For illustration purposes, the following descriptions are described with reference to a current iteration.

In some embodiment, to generate the data processing model, for a sample image pair in the training sample set, the processing device 140B may generate, based on a sample image of the sample image pair, a predicted image using the preliminary machine learning model (or an intermediate machine learning model determined in a prior iteration). Further, the processing device 140B may determine, based on the predicted image and a reference image of the training data pair, a value of a loss function. The loss function may be used to measure a difference between the predicted image and a reference image of the training data pair. Further, the processing device 140B may determine, based on the value of the loss function, whether a termination condition is satisfied in the current iteration. Exemplary termination conditions may include that the value of the loss function obtained in the current iteration is less than a predetermined threshold, a certain count of iterations is performed, that the loss function converges such that the differences of the values of the loss function obtained in consecutive iterations are within a threshold, or the like, or any combination thereof. In response to determining that the termination condition is satisfied in the current iteration, the processing device 140B may designate the preliminary machine learning model (or the intermediate machine learning model) as the data processing model.

In some embodiment, to generate the data processing model, the processing device 140B may transform a sample image and a reference image of the sample image pair from a first form (e.g., a Cartesian coordinate form) to a second form (e.g., a polar coordinate form). Further, the processing device 140B may generate the data processing model by training, based on the training sample set including a plurality of sample image pairs in the second form, the preliminary machine learning model. In some embodiments, data in the second form may be easier to process, which may improve the efficiency of the training of the preliminary machine learning model.

It should be noted that the above descriptions regarding the process 900 is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure. In some embodiments, the order of the process 900 and/or the process 900 may not be intended to be limiting. In some embodiment, one or more operations of the process 900 may be omitted. For example, the operation 940 may be omitted. The raw data may be used as the reference data, and the modified data may be used as the first data directly for training the preliminary machine learning model. As another example, the operation 950 may be omitted. The process 900 may be used as a process for generating, by simulation, a training data pair.

In some embodiments, the operation 920 may be omitted. The processing device 140B may remove data from the initial image directly. For example, the processing device 140B may determine a third scan fan angle less than the first scan fan angle such that at least a portion of the sample subject may extend beyond the scan FOV of the imaging device corresponding to the third scan fan angle. Further, the processing device 140B may generate raw data by performing, based on the initial image and the first scan fan angle, a forward projection. Further, the processing device 140B may generate modified data by removing, from the raw data, data corresponding to a difference scan fan angle between the first scan fan angle and the second scan fan angle. Further, the processing device 140B may generate the sample image by performing, based on the modified data, a backward projection. And the initial image may be designated as the reference image. In the initial image, the sample subject may be completely covered by the first scan fan angle. And to obtain the modified data, data relating to a portion of the sample subject may be remove from the raw data. Correspondingly, the modified data may be considered to be truncated. In such cases, when the sample image is generated by performing, based on the modified data, the backward projection, a truncation artifact may be introduced into the sample image.

FIG. 11 is a flowchart illustrating an exemplary process for obtaining a training sample set according to some embodiments of the present disclosure. In some embodiments, process 1100 may be executed by an imaging system (e.g., the imaging system 100). In some embodiments, the imaging system may be implemented by software and/or hardware. In some embodiments, at least part of process 1100 may be performed by the processing device 140 (implemented in, for example, the computing device 200 shown in FIG. 2). For example, the process 1100 may be stored in a storage device (e.g., the storage device 150, the storage 220, the storage 390) in the form of instructions (e.g., an application), and invoked and/or executed by the processing device 140 (e.g., the processor 210 illustrated in FIG. 2, the CPU 340 illustrated in FIG. 3, one or more modules illustrated in FIG. 4). The operations of the illustrated process presented below are intended to be illustrative. In some embodiments, the process 1100 may be accomplished with one or more additional operations not described, and/or without one or more of the operations discussed. Additionally, the order in which the operations of the process 1100 as illustrated in FIG. 11 and described below is not intended to be limiting. In some embodiments, the operation 810 may be achieved according to the process 1100. For example, the process 1100 may be performed for generating, by simulation, a training data pair. The training data pair may include a sample image and a reference image. For illustration purposes, the following descriptions are described with reference to the implementation of the process 1100 by the processing device 140B, and not intended to limit the scope of the present disclosure.

In 1110, the processing device 140B (e.g., the obtaining module 440) may obtain an initial image of a sample subject acquired by an imaging device.

In some embodiments, the initial image may be deemed to have no truncation artifact. For example, the sample subject may be completely covered by a scan FOV of the imaging device such that the sample subject may be fully scanned. As used herein, an initial image deemed to have no truncation artifact refers to that the initial image is considered to have no truncation artifact or has no observable truncation artifact based on a truncation artifact detection method. Such a truncation artifact detection method may be performed automatically based on a truncation artifact detection algorithm, or manually by an operator (e.g., a physician, an imaging technician, etc.).

In some embodiments, the processing device 140B may obtain the initial image by causing the imaging device to scan the sample subject. In some embodiments, the initial image may be acquired in a scan of the sample subject using the imaging device and stored in a storage device (e.g., the storage device 150, the storage 220, and/or the storage 390). The processing device 140B may access the storage device and retrieve the initial image.

In 1120, for the initial image, the processing device 140B (e.g., the obtaining module 440) may determine a first reconstruction center according to which the initial image is reconstructed. For example, the initial image may be reconstructed, according to one or more reconstruction parameters stored in a storage device (e.g., the storage device 150, the storage 220, and/or the storage 390). The one or more reconstruction parameters may include the first reconstruction center. The processing device 140B may access the storage device and retrieve the first reconstruction center. As another example, the processing device 140B may determine the first reconstruction center by analyzing the initial image directly using an image processing technique.

In 1130, the processing device 140B (e.g., the obtaining module 440) may determine a second reconstruction center for the initial image that is different from the first reconstruction center. In some embodiments, the second reconstruction center may be different from the first reconstruction center such that at least a portion of the sample subject may extend beyond the scan FOV of the imaging device. In some embodiments, the processing device 140B may determine the second reconstruction center based on a distance between an edge of (a representation of) the sample subject and an edge of the initial image. For example, the processing device 140B may determine the distance between the edge of the sample subject and the edge of the initial image using an image processing technique. A distance between the second reconstruction center and the first reconstruction center may be determined to be larger than the distance between the edge of the sample subject and the edge of the initial image such that a portion sample subject is outside the scan FOV when the second reconstruction center is used in generating the raw data.

In 1140, the processing device 140B (e.g., the obtaining module 440) may generate raw data by performing, based on the initial image and the second reconstruction center, a forward projection.

In some embodiments, the second reconstruction center may be different from the first reconstruction center such that least a portion of the sample subject may extend beyond the scan FOV of the imaging device in the raw data. For example, the initial image may be obtained by performing an actual scan on the sample subject using the scan FOV. In the initial image reconstructed according to the first reconstruction center, the sample subject may be completely included in the initial image. During the forward projection, if the first reconstruction center is adjusted, a position of the sample subject in the initial image may change correspondingly. For instance, a portion of the sample subject may extend beyond the initial image due to the adjustment, for example, when the distance between the second reconstruction center and the first reconstruction center is larger than the distance between the edge of the sample subject and the edge of the initial image. The forward projection may be performed to simulate a scan using the scan FOV on the sample subject while the portion that extends beyond the initial image due to the adjustment is omitted. Raw data may be simulated by the forward projection. The raw data so determined may miss the data relating to the portion of the sample subject that extends beyond the initial image due to the adjustment, and accordingly be considered to be truncated.

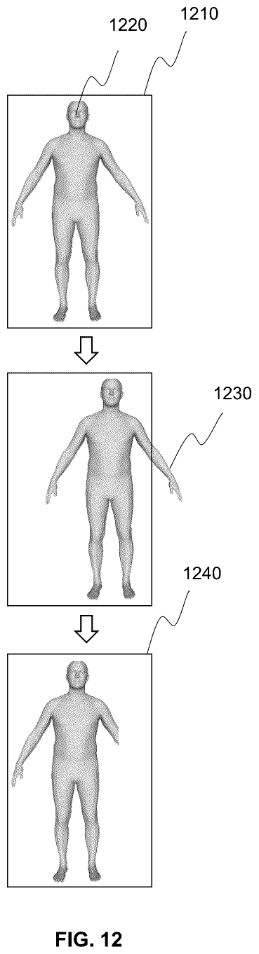

FIG. 12 is a schematic diagram illustrating an exemplary simulated scan corresponding to the forward projection according to some embodiments of the present disclosure. As illustrated in FIG. 12, in an initial image 1210 reconstructed according to a first reconstruction center, a sample subject 1220 may be completely included in the initial image 1210. The initial image 1210 may be deemed to have no truncation artifact. To generate the raw data by simulation, a second reconstruction center different from the first reconstruction center may be determined such that a portion 1230 of the sample subject 1220 may extend beyond the initial image. Further, in the simulated scan corresponding to the forward projection based on the initial image 1210 and the second reconstruction center, the sample subject 1220 without the portion 1230 may be scanned using the scan FOV. In such cases, the raw data 1240 generated in the simulated scan may be considered to be truncated, which may result in a truncation artifact in the sample image.

In 1150, the processing device 140B (e.g., the obtaining module 440) may generate a training data pair based on the raw data.

In some embodiments, to generate the training data pair based on the raw data, the processing device 140B may generate the sample image by performing, based on the raw data, a backward projection. Further, the processing device 140B may designate the initial image as the reference image. In some embodiments, since the raw data 1240 in operation 1140 is considered to be truncated, when the sample image is generated by performing, based on the raw data, the backward projection, a truncation artifact may be generated in the sample image.

According to some embodiments of the present disclosure, the sample image and the reference image may be generated according to a simulation process performed based on a plurality of initial images deemed to have no truncation artifact. This may obviate the need of performing actual scans on the plurality of sample subjects, which may improve the efficiency of training the preliminary machine learning model. Additionally, a large amount of training data pairs including the sample image and the reference image may be obtained according to the simulation process, which may improve the accuracy of training the preliminary machine learning model.

The process 1100 may be repeated to generate, based on a plurality of initial images, a training sample set including a plurality of training data pairs. In some embodiment, the plurality of initial images may be acquired by a same imaging device, or different imaging devices of a same type (e.g., initial images acquired using different CT scanners) or of different types (e.g., initial images acquired using at least one CT scanner and at least one PET scanner). In some embodiment, the plurality of initial images may be acquired by scanning a same sample subject in plurality of scans, or may be acquired by scanning different sample subjects.

It should be noted that the above descriptions regarding the process 1100 is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure. In some embodiments, the order of the process 1100 and/or the process 1100 may not be intended to be limiting.

In some embodiments, the process 900 and the process 1100 may be executed as a single process. That is, a training data pair generated according to process 900 and a training data pair generated according to process 1100 may be used as training data pairs in a same training sample set for training a preliminary machine learning model.

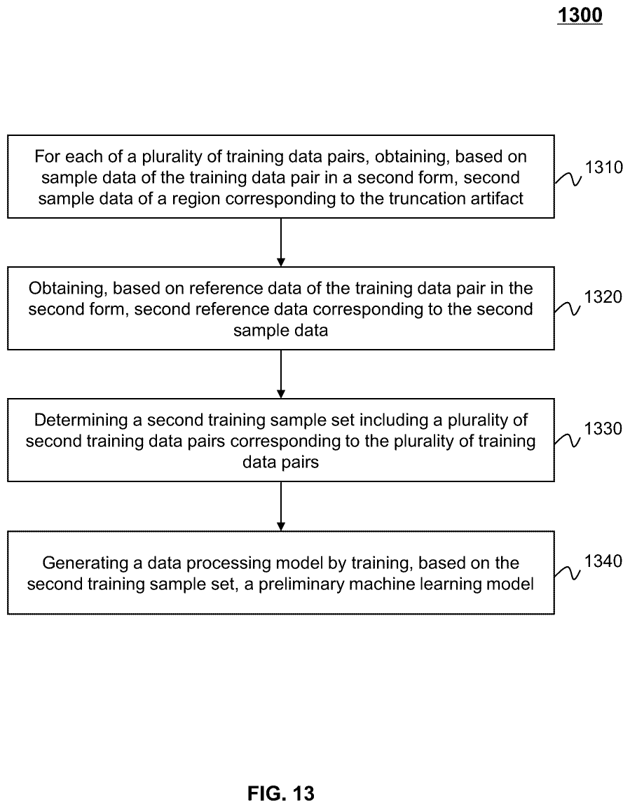

FIG. 13 is a flowchart illustrating an exemplary process for generating a data processing model according to some embodiments of the present disclosure. In some embodiments, process 1300 may be executed by an imaging system (e.g., the imaging system 100). In some embodiments, the imaging system may be implemented by software and/or hardware. In some embodiments, at least part of process 1300 may be performed by the processing device 140 (implemented in, for example, the computing device 200 shown in FIG. 2). For example, the process 1300 may be stored in a storage device (e.g., the storage device 150, the storage 220, the storage 390) in the form of instructions (e.g., an application), and invoked and/or executed by the processing device 140 (e.g., the processor 210 illustrated in FIG. 2, the CPU 340 illustrated in FIG. 3, one or more modules illustrated in FIG. 4). The operations of the illustrated process presented below are intended to be illustrative. In some embodiments, the process 1300 may be accomplished with one or more additional operations not described, and/or without one or more of the operations discussed. Additionally, the order in which the operations of the process 1300 as illustrated in FIG. 13 and described below is not intended to be limiting. Alternatively, the process 1300 may be performed by a computing device of a system of a vendor that provides and/or maintains such data processing model, wherein the system of the vendor is different from the imaging system 100. In some embodiments, the operation 820 may be achieved according to the process 1300. For illustration purposes, the following descriptions are described with reference to the implementation of the process 1300 by the processing device 140B, and not intended to limit the scope of the present disclosure.

In 1310, for each of the plurality of training data pairs in a training sample set, the processing device 140B (e.g., the model generation module 440) may transform a sample image and a reference image of the training data pair from a first form to a second form.

In some embodiments, the first form may include a Cartesian coordinate form. In some embodiments, the second form may include a polar coordinate form. In some embodiments, the processing device 140B may transform the sample image from the first form to the second form using a transformation algorithm. Exemplary transformation algorithm may include a Coordinate Rotation Digital Computer (CORDIC) algorithm, an algorithm based on transformation functions, or the like, or any combination thereof.

In some embodiments, as described in connection with FIG. 6A, the sample image and the reference image in the second form may be easier to process, which may improve the efficiency of generating the data processing model.

In some embodiments, the sample image may include a truncation artifact. The reference image may be deemed to have no truncation artifact.

In 1310, for each of the plurality of training data pairs in a training sample set, the processing device 140B (e.g., the model generation module 460) may obtain, based on sample data in a second form, second sample data of a region corresponding to the truncation artifact.

In some embodiments, the second sample data may be obtained in a similar manner as the obtaining of the second data as described in connection with FIG. 6A. For example, the processing device 140B may determine a first sample region inside a region of the sample truncation artifact. Further, the processing device 140A may determine the region corresponding to the sample truncation artifact based on the first region. Data of the region corresponding to the sample truncation artifact may be designated as the second sample data.

In 1320, the processing device 140B (e.g., the model generation module 460) may obtain, based on reference data of the training data pair in the second form, second reference data corresponding to the second sample data.

In some embodiments, as described in connection with FIG. 10, the sample data and the reference data may have a same size. For example, the sample data and the reference data may be expressed in the form of a matrix, respectively. The matrix corresponding to the sample data may have a same dimension as the matrix corresponding to the reference data. Additionally, elements (e.g., pixels, or voxels) in a same matrix position of the two matrices, or referred to as corresponding elements, may correspond to a same position of the sample subject. Accordingly, the processing device 140B may determine, in the reference data, a corresponding region at a same position as the region corresponding to the truncation artifact. Data (e.g., an image of the corresponding region may be designated as the second reference data corresponding to the second sample data.

In 1330, the processing device 140B (e.g., the model generation module 460) may determine a second training sample set including a plurality of second training data pairs corresponding to the plurality of training data pairs. Each of the plurality of second training data pairs may include second sample data and corresponding second reference data.

In 1340, the processing device 140B (e.g., the model generation module 460) may generate the data processing model by training, based on the second training sample set, the preliminary machine learning model.

The training of the preliminary machine learning model may include one or more iterations. For illustration purposes, the following descriptions are described with reference to a current iteration. In the current iteration, the processing device 140B may input the second sample data of a second training data pair into the preliminary machine learning model in the current iteration (or an intermediate machine learning model determined in a prior iteration) to obtain a predicted data. The processing device 140B may determine a value of a loss function based on the predicted data and the second reference data of the second training data pair. The loss function may be used to measure a difference between the predicted data and the second reference data of the second training data pair. The processing device 140B may determine whether a termination condition is satisfied in the current iteration. More descriptions regarding training the preliminary machine learning model may be found elsewhere in the present disclosure. See, e.g., FIG. 14 and relevant descriptions thereof.

According to the training process of the preliminary machine learning model, the second sample data and the second reference data may be used to train the preliminary machine learning model. The second sample data may mainly include the truncation artifact, which may provide effective data for training the preliminary machine learning model. Compared with the training process based on the entire sample data, such methods may focus on the processing of the truncation artifact, which may improve the efficiency of training the preliminary machine learning model.

It should be noted that the above descriptions regarding the process 1300 is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure. In some embodiments, the order of the process 1300 and/or the process 1300 may not be intended to be limiting. For example, the process 1300 may include an operation for transforming the sample data and the reference data from the first form to the second form.

FIG. 14 is a flowchart illustrating an exemplary process for training a preliminary machine learning model based on a second training sample set according to some embodiments of the present disclosure. In some embodiments, process 1400 may be executed by an imaging system (e.g., the imaging system 100). In some embodiments, the imaging system may be implemented by software and/or hardware. In some embodiments, at least part of process 1400 may be performed by the processing device 140 (implemented in, for example, the computing device 200 shown in FIG. 2). For example, the process 1400 may be stored in a storage device (e.g., the storage device 150, the storage 220, the storage 390) in the form of instructions (e.g., an application), and invoked and/or executed by the processing device 140 (e.g., the processor 210 illustrated in FIG. 2, the CPU 340 illustrated in FIG. 3, one or more modules illustrated in FIG. 4). The operations of the illustrated process presented below are intended to be illustrative. In some embodiments, the process 1400 may be accomplished with one or more additional operations not described, and/or without one or more of the operations discussed. Additionally, the order in which the operations of the process 1400 as illustrated in FIG. 14 and described below is not intended to be limiting. Alternatively, the process 1400 may be performed by a computing device of a system of a vendor that provides and/or maintains such data processing model, wherein the system of the vendor is different from the imaging system 100. In some embodiments, the operation 1340 may be achieved according to the process 1400. For illustration purposes, the following descriptions are described with reference to the implementation of the process 1400 by the processing device 140B, and not intended to limit the scope of the present disclosure.

In some embodiments, the training of the preliminary machine learning model may include one or more iterations. For illustration purposes, the following descriptions are described with reference to a current iteration.

In 1410, for a second training data pair in the second training sample set, the processing device 140B (e.g., the model generation module 460) may generate, based on second sample data of the second training data pair, intermediate data in the second form using the preliminary machine learning model in the current iteration (or an intermediate machine learning model determined in a prior iteration).

In some embodiments, similar to the intermediate data generated in the application of the data processing mode as described in connection with FIG. 6A, the intermediate data may be configured to correct a sample truncation artifact in the second sample data. Additionally, the intermediate data may also be configured to improve or supplement data relating to one or more portions of the subject that are obstructed or extend beyond the scan FOV in the second sample data.

In 1420, the processing device 140B (e.g., the model generation module 460) may generate, predicted data by combining the second sample data and the intermediate data.

In some embodiments, the intermediate data and the second sample data may have a same size. In the combination of the second sample data and the intermediate data, the processing device 140B may fuse data in the second sample data with corresponding data in the intermediate data.

In 1430, the processing device 140B (e.g., the model generation module 460) may determine, based on the predicted data and second reference data of each second training data pair, a value of a loss function. The loss function may be used to measure a difference between the predicted data and the second reference data of the second training data pair.

In 1440, the processing device 140B (e.g., the model generation module 460) may determine, based on the value of the loss function, whether a termination condition is satisfied in the current iteration.

Exemplary termination conditions may include that the value of the loss function obtained in the current iteration is less than a predetermined threshold, a certain count of iterations is performed, that the loss function converges such that the differences of the values of the loss function obtained in consecutive iterations are within a threshold, or the like, or any combination thereof.

In 1450, in response to determining that the termination condition is satisfied in the current iteration, the processing device 140B (e.g., the model generation module 460) may designate the preliminary machine learning model in the current iteration (or the intermediate machine learning model) as the data processing model. Additionally or alternatively, the processing device 140B may further store the data processing model into a storage device (e.g., the storage device 150, the storage 220, and/or the storage 390) of the imaging system 100 and/or output the data processing model for further use (e.g., in process 500 and/or process 600). In some embodiments, if the termination condition is not satisfied in the current iteration, the processing device 140B may update the preliminary machine learning model in the current iteration and proceed to a next iteration. For example, the processing device 140B may update the value(s) of model parameter(s) of the preliminary machine learning model based on the value of the loss function according to, for example, a backpropagation algorithm.

It should be noted that the above descriptions regarding the process 1400 is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure. In some embodiments, the order of the process 1400 and/or the process 1400 may not be intended to be limiting.

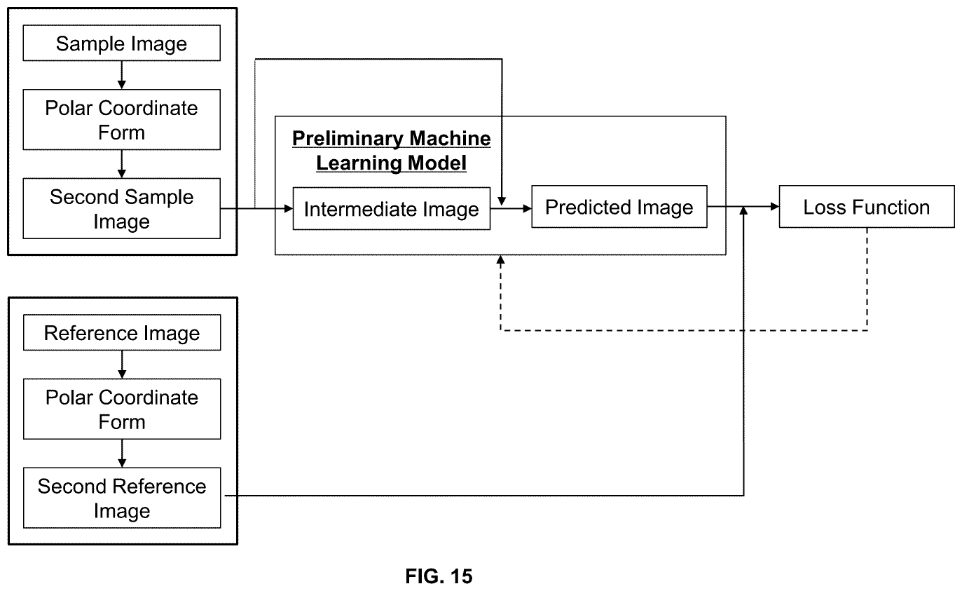

FIG. 15 is a schematic diagram illustrating an exemplary training process of a preliminary machine learning model according to some embodiments of the present disclosure. As illustrated in FIG. 15, in a current iteration, a sample image and a reference image may be transformed from a Cartesian coordinate form to a polar coordinate form. The first image may include a truncation artifact. Further, a second sample image may be obtained based on the sample image in the polar coordinate form. And a second reference image may be obtained based on the reference image in the polar coordinate form. The second sample image may be of a region corresponding to the truncation artifact. The second reference image may correspond to the second sample image. The second sample image may be input into the preliminary machine learning model to obtain an intermediate image. The intermediate image may be combined with the second sample image to obtain a predicted image. Further, a value of a loss function may be determined based on the predicted image and the second reference image. Model parameter(s) of the preliminary machine learning model may be updated based on the value of the loss function until a termination condition is satisfied in the current iteration. If the termination condition is satisfied in the current iteration, the preliminary machine learning model in the current iteration may be designate the as a data processing model.

It should be noted that the example illustrated in FIG. 15 and the above description thereof are merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure.

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended to those skilled in the art, though not expressly stated herein. These alterations, improvements, and modifications are intended to be suggested by this disclosure, and are within the spirit and scope of the exemplary embodiments of this disclosure.

Moreover, certain terminology has been used to describe embodiments of the present disclosure. For example, the terms “one embodiment,” “an embodiment,” and/or “some embodiments” mean that a particular feature, structure or characteristic described in connection with the embodiment is included in at least one embodiment of the present disclosure. Therefore, it is emphasized and should be appreciated that two or more references to “an embodiment” or “one embodiment” or “an alternative embodiment” in various portions of this disclosure are not necessarily all referring to the same embodiment. Furthermore, the particular features, structures or characteristics may be combined as suitable in one or more embodiments of the present disclosure.

Further, it will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “unit,” “module,” or “system.” Furthermore, aspects of the present disclosure may take the form of a computer program product embodied in one or more computer readable media having computer readable program code embodied thereon.

A computer readable signal medium may include a propagated data signal with computer readable program code embodied therein, for example, in baseband or as part of a carrier wave. Such a propagated signal may take any of a variety of forms, including electro-magnetic, optical, or the like, or any suitable combination thereof. A computer readable signal medium may be any computer readable medium that is not a computer readable storage medium and that may communicate, propagate, or transport a program for use by or in connection with an instruction performing system, apparatus, or device. Program code embodied on a computer readable signal medium may be transmitted using any appropriate medium, including wireless, wireline, optical fiber cable, RF, or the like, or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C #, VB. NET, Python or the like, conventional procedural programming languages, such as the “C” programming language, Visual Basic, Fortran 2103, Perl, COBOL 2102, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Furthermore, the recited order of processing elements or sequences, or the use of numbers, letters, or other designations therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose, and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software only solution, e.g., an installation on an existing server or mobile device.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various inventive embodiments. This method of disclosure, however, is not to be interpreted as reflecting an intention that the claimed subject matter requires more features than are expressly recited in each claim. Rather, inventive embodiments lie in less than all features of a single foregoing disclosed embodiment.

In some embodiments, the numbers expressing quantities or properties used to describe and claim certain embodiments of the application are to be understood as being modified in some instances by the term “about,” “approximate,” or “substantially.” For example, “about,” “approximate,” or “substantially” may indicate ±20% variation of the value it describes, unless otherwise stated. Accordingly, in some embodiments, the numerical parameters set forth in the written description and attached claims are approximations that may vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the application are approximations, the numerical values set forth in the specific examples are reported as precisely as practicable.

Each of the patents, patent applications, publications of patent applications, and other material, such as articles, books, specifications, publications, documents, things, and/or the like, referenced herein is hereby incorporated herein by this reference in its entirety for all purposes, excepting any prosecution file history associated with same, any of same that is inconsistent with or in conflict with the present document, or any of same that may have a limiting affect as to the broadest scope of the claims now or later associated with the present document. By way of example, should there be any inconsistency or conflict between the description, definition, and/or the use of a term associated with any of the incorporated material and that associated with the present document, the description, definition, and/or the use of the term in the present document shall prevail.

In closing, it is to be understood that the embodiments of the application disclosed herein are illustrative of the principles of the embodiments of the application. Other modifications that may be employed may be within the scope of the application. Thus, by way of example, but not of limitation, alternative configurations of the embodiments of the application may be utilized in accordance with the teachings herein. Accordingly, embodiments of the present application are not limited to that precisely as shown and described.

What is claimed is:

1. A method for data processing, implemented on a computing device having at least one storage device storing a set of instructions, and at least one processor in communication with the at least one storage device, the method comprising:
obtaining first data of a subject acquired by an imaging device, the first data relating to a truncation artifact;
transforming the first data from a first form to a second form; and
generating, based on the first data in the second form, truncation artifact corrected data using a data processing model.

2. The method of claim 1, wherein the generating, based on the first data in the second form, truncation artifact corrected data using a data processing model includes:
generating, based on the first data in the second form, truncation artifact corrected data in the second form using the data processing model; and
transforming the truncation artifact corrected data from the second form to the first form.

3. The method of claim 1, wherein the generating, based on the first data in the second form, truncation artifact corrected data using a data processing model further includes:
obtaining, based on the first data in the second form, second data of a region corresponding to the truncation artifact; and
generating, based on the first data and the second data, the truncation artifact corrected data using the data processing model.

4. The method of claim 1, wherein the first form includes a Cartesian coordinate form, and the second form includes a polar coordinate form.

5. The method of claim 3, wherein the generating, based on the first data and the second data, the truncation artifact corrected data using the data processing model includes:
generating, based on the second data, intermediate data in the second form, the intermediate data being configured to correct the truncation artifact; and
generating the truncation artifact corrected data by combining the first data and the intermediate data.

6. The method of claim 5, wherein the generating the truncation artifact corrected data by combining the first data and the intermediate data includes:
determining weighted intermediate data based on a weight;
transforming the weighted intermediate data from the second form to the first form; and
determining the truncation artifact corrected data by combining the first data and the weighted intermediate data in the first form.

7. A method for generating a data processing model, implemented on a computing device having at least one storage device storing a set of instructions, and at least one processor in communication with the at least one storage device, the method comprising:
obtaining a training sample set including a plurality of training data pairs, wherein each of the plurality of training data pairs includes sample data and reference data of a same sample subject, and the sample data relates to a sample truncation artifact;
for each of the plurality of training data pairs,
transforming sample data and reference data of the training data pair from a first form to a second form; and
generating the data processing model by training, based on the training sample set including a plurality of training data pairs in the second form, a preliminary machine learning model, the data processing model being configured to generate truncation artifact corrected data.

8. The method of claim 7, the training, based on the training sample set including a plurality of training data pairs in the second form, a preliminary machine learning model includes one or more iterations, at least one current iteration of which includes:
for each of at least one training data pair in the training sample set, generating, based on sample data of the training data pair, predicted data using the preliminary machine learning model or an intermediate machine learning model determined in a prior iteration;
determining, based on the predicted data and reference data of the training data pair, a value of a loss function;
determining, based on the value of the loss function, whether a termination condition is satisfied in the current iteration; and
in response to determining that the termination condition is satisfied in the current iteration, designating the preliminary machine learning model or the intermediate machine learning model as the data processing model.

9. The method of claim 7, wherein the generating the data processing model by training, based on the training sample set including a plurality of training data pairs in the second form, a preliminary machine learning model includes:
for each of the plurality of training data pairs,
obtaining, based on sample data of the training data pair in the second form, second sample data of a region corresponding to the sample truncation artifact; and
obtaining, based on reference data of the training data pair in the second form, second reference data corresponding to the second sample data;
determining a second training sample set including a plurality of second training data pairs corresponding to the plurality of training data pairs, wherein each of the plurality of second training data pairs includes second sample data and corresponding second reference data; and
generating the data processing model by training, based on the second training sample set, the preliminary machine learning model.

10. The method of claim 9, wherein the first form includes a Cartesian coordinate form, and the second form includes a polar coordinate form.

11. The method of claim 9, wherein the training, based on the second training sample set, the preliminary machine learning model includes one or more iterations, and at least one current iteration of the one or more iterations includes:
for each of at least one second training data pair in the second training sample set,
generating, based on second sample data of the second training data pair, intermediate data in the second form using the preliminary machine learning model or an intermediate machine learning model determined in a prior iteration, the intermediate data being configured to correct the sample truncation artifact; and
generating predicted data by combining the second sample data and the intermediate data;
determining, based on the predicted data and second reference data of the second training data pair, a value of a loss function;
determining, based on the value of the loss function, whether a termination condition is satisfied in the current iteration; and
in response to determining that the termination condition is satisfied in the current iteration, designating the preliminary machine learning model or the intermediate machine learning model as the data processing model.

12. The method of claim 7, wherein the sample data includes a sample image including the sample truncation artifact, the reference data includes a reference image having no sample truncation artifact, and the obtaining a training sample set including a plurality of training data pairs includes:
obtaining a plurality of initial images of a plurality of sample subjects acquired by an imaging device, the plurality of initial images corresponding to a first scan fan angle and having no truncation artifact; and
for each of the plurality of initial images,
determining a second scan fan angle less than the first scan fan angle such that at least a portion of the sample subject extends beyond a scan field of view (FOV) of the imaging device corresponding to the second scan fan angle; and
generating raw data by performing, based on the initial image and the first scan fan angle, a forward projection; and
generating, based on the raw data, a training data pair including a sample image and a reference image.

13. The method of claim 12, wherein the generating, based on the raw data, a training data pair including a sample image and a reference image includes:
generating modified data by removing, from the raw data, data corresponding to a difference scan fan angle between the first scan fan angle and the second scan fan angle; and
generating the sample image by performing, based on the modified data, a backward projection.

14. The method of claim 12, wherein the generating, based on the raw data, a training data pair including a sample image and a reference image further includes:
designating the initial image as the reference image.

15. The method of claim 12, wherein the obtaining a training sample set including a plurality of training data pairs includes:
obtaining a plurality of initial images of a plurality of sample subjects acquired by an imaging device, the plurality of initial images having no truncation artifact;
for each of the plurality of initial images,
determining a first reconstruction center according to which the initial image is reconstructed;
determining a second reconstruction center for the initial image;
generating raw data by performing, based on the initial image and the second reconstruction center, a forward projection, wherein the second reconstruction center is different from the first reconstruction center such that at least a portion of the sample subject extends beyond a scan field of view (FOV) of the imaging device; and
generating a training data pair based on the raw data.

16. The method of claim 15, wherein the generating a training data pair based on the raw data includes:
generating the sample image by performing, based on the raw data, a backward projection.

17. The method of claim 15, wherein the generating a training data pair based on the raw data includes:
designating the initial image as the reference image.

18. A method for generating a data processing model, implemented on a computing device having at least one storage device storing a set of instructions, and at least one processor in communication with the at least one storage device, the method comprising:
obtaining a plurality of initial images of a plurality of sample subjects acquired by an imaging device, the plurality of initial images corresponding to a first scan fan angle and having no truncation artifact; and
determining a training sample set including a plurality of sample image pairs based on the plurality of initial images by a process including, for each of the plurality of initial images,
determining a second scan fan angle including an extended scan fan angle with respect to the first scan fan angle;
generating raw data by performing, based on the initial image and the second scan fan angle, a forward projection; and
generating, based on the raw data, a sample image pair including a sample image and a reference image; and
generating the data processing model by training, based on the training sample set, a preliminary machine learning model.

19. The method of claim 18, wherein the generating, based on the raw data, a sample image pair including a sample image and a reference image includes:
generating modified data by removing data corresponding to the extended scan fan angle from the raw data; and
generating the sample image by performing, based on the modified data, a backward projection.

20. The method of claim 18, wherein the generating, based on the raw data, a training data pair including a sample image and a reference image further includes:
determining the reference image by performing, based on the raw data, a backward projection.
